(19) United States
(12) Patent Application Publication
(10) Pub. No.: US 2001/0007506 A1
(43) Pub. Date: Jul. 12, 2001

(54) Optical transmitter, wavelength (division) multiplex optical transmitter, time division multiplex optical transmitter, optical receiver, wavelength (division) multiplex optical receiver, time division multiplex optical receiver, and an optical trasmission system using these devices

(76) Inventor: Satoshi Mikami, Minato-ku (JP)

Correspondence Address: OSTROLENK FABER GERB & SOFFEN, 1180 AVENUE OF THE AMERICAS, NEW YORK, NY, 100368403

(21) Appl. No.: 09/754,784

(22) Filed: Jan. 4, 2001

Related U.S. Application Data
(62) Division of application No. 09/271,418, filed on Mar. 17, 1999, now abandoned.

(30) Foreign Application Priority Data
Mar. 17, 1998 (JP) 10-067434
Mar. 17, 1998 (JP) 10-067435

(51) Int. Cl. H04B 10/06

(52) U.S. Cl. 359/189; 359/191

(57) ABSTRACT

The invention is directed toward realizing an optical transmitter, a wavelength division multiplex optical transmitter, a time division multiplex optical transmitter, an optical receiver, a wavelength division multiplex optical receiver, a time division multiplex optical receiver, and an optical transmission system using these devices, in which the signal-to-noise ratio of a signal beam is improved. Each transmitter and receiver is provided with a saturable absorbing optical element having a saturable absorbing region that receives and outputs a signal beam.

### BACKGROUND OF THE INVENTION

1. Field of the Invention

The present invention relates to an optical transmitter, a wavelength division multiplex optical transmitter, a time division multiplex optical transmitter, an optical receiver, a wavelength division multiplex optical receiver, and a time division multiplex optical receiver having improved signal-to-noise ratio of optical pulse signals used in data communication, and an optical transmission system using these devices.

2. Description of the Related Art

In recent years, wavelength synthesizing transmission systems have received attention as a means for achieving greater transmission volume. In a wavelength synthesizing transmission system, the characteristic of an optical amplifier is of key importance, and broadband, high-stability rare-earth doped optical fiber amplifiers are typically widely used as the optical amplifiers provided on both the optical transmitter side and optical receiver side.

A laser device is used as the signal beam source, and the signal beam is produced by modulating with a modulator, amplified by rare-earth doped optical fiber amplifier, and transmitted.

Spontaneous emission light of the optical fiber itself is emitted when amplifying a signal beam in a rare-earth doped optical fiber amplifier. When amplifying to raise the output of a signal beam outputted by a signal beam source in an optical transmitter or optical receiver provided with the above-described optical fiber amplifier of the prior art, the noise generated by the rare-earth doped optical fiber amplifier itself is added to the signal beam and degrades the signal-to-noise ratio.

There is the additional problem of degradation of the signal-to-noise ratio due to the poor extinction ratio after modulation resulting from the admixture of side-mode oscillation and noise generated by the laser device itself, i.e., the signal beam source, as well as by components other than these signal beam components. The present invention was achieved in view of the problems of the above-described prior art and has the object of realizing an optical transmitter, wavelength division multiplex optical transmitter, time division multiplex optical transmitter, optical receiver, wavelength division multiplex optical receiver, and time division multiplex optical receiver all having a signal beam of improved signal-to-noise ratio, as well as an optical transmission system using these devices.

### SUMMARY OF THE INVENTION

According to the present invention, an optical transmitter, which transmits a signal beam generated by a transmission circuit to a transmission line, includes: a saturable absorbing optical element having a saturable absorbing region that receives the signal beam generated by the transmission circuit and outputs to a transmission line.

According to another form of the invention, an optical transmitter, which transmits a signal beam generated by a transmission circuit to a transmission line, includes:

a light source that generates an offset beam; an optical mixer that receives and mixes a signal beam generated by the transmission circuit with an offset beam generated by the light source; and

a saturable absorbing optical element having a saturable absorbing region that receives the output of the optical mixer and outputs to a transmission line.

According to another form of the invention, an optical transmitter, which transmits a signal beam generated by a transmission circuit to a transmission line, includes:

a light source that generates an offset beam; a saturable absorbing optical element having a saturable absorbing region that receives the signal beam generated by the transmission circuit; and

an optical mixer that receives an offset beam generated by the light source and outputs it toward the saturable absorbing optical element, and outputs the output of the saturable absorbing optical element to a transmission line.

According to another form of the invention, an optical transmitter, which transmits a signal beam generated by a transmission circuit to a transmission line, includes:

first and second light sources that generate first and second offset beams;

a first optical mixer that receives a signal beam generated by the transmission circuit and a first offset beam generated by the first light source and mixes these two beams;

a saturable absorbing optical element having a saturable absorbing region that receives the output of the first optical mixer; and

a second optical mixer that receives a second offset beam generated by the second light source and outputs it toward the saturable absorbing optical element, and outputs the output of the saturable absorbing optical element to a transmission line.

According to another form of the invention, an optical transmitter, which transmits a signal beam generated by a transmission circuit to a transmission line, includes:

a light source that generates an offset beam; an optical dividing means that receives an offset beam generated by the light source, divides the beam into first and second offset beams, and outputs the offset beams;

a first optical mixer that receives a signal beam generated by the transmission circuit and the first offset beam divided by the optical dividing means and mixes these two beams;

a saturable absorbing optical element having a saturable absorbing region that receives the output of the first optical mixer; and

a second optical mixer that receives the second offset beam divided by the optical dividing means, outputs the second offset beam toward the saturable absorbing optical element, and outputs the output of the saturable absorbing optical element to a transmission line.

Any of the above-described cases may include a means, provided in the section following the transmission circuit, for transmitting a signal beam outputted by the transmission circuit in only one direction.

In addition, any of the above-described cases may include a first wavelength selecting means, provided as the output section of the optical transmitter, that does not transmit the offset beam component.

An optical amplifier may be provided in the section preceding the saturable absorbing optical element, i.e., on the transmission circuit side of the saturable absorbing optical element.

An optical amplifier may be provided in the section following the saturable absorbing optical element, i.e., on the transmission line side of the saturable absorbing optical element.

A first optical amplifier may be provided in the section preceding the saturable absorbing optical element, i.e., on the transmission circuit side of the saturable absorbing optical element; and a second optical amplifier may be provided in the section following the saturable absorbing optical element, i.e., on the transmission line side of the saturable absorbing optical element.

In addition, any of the above-described cases may include a second wavelength selecting means, provided as the output section of the optical transmitter, that transmits only the signal beam bandwidth.

Finally, any of the above-described cases may include a dispersion compensating circuit having the function of compensating dispersion.

A wavelength division multiplex optical transmitter of the present invention includes:

a plurality of optical transmitters constructed as described hereinabove that each generate a signal beam of different wavelength; and

an optical coupler that multiplexes each signal beam from the plurality of transmitters and transmits to a transmission line.

According to another form of the invention, an optical transmitter includes:

a plurality of transmitter systems, each made up of a transmission circuit that generates a signal beam, an optical mixer that receives a signal beam generated by the transmission circuit and an offset beam and mixes these two beams, and a saturable absorbing optical element having a saturable absorbing region that receives the output of the optical mixer;

a light source that generates an offset beam;

an optical dividing means that receives an offset beam generated by the light source, divides the offset beam into a plurality of offset beams, and supplies an offset beam to each of the optical mixers that form a part of the plurality of transmission systems; and an optical coupler that multiplexes the plurality of signal beams outputted from the plurality of transmission systems.

According to another form of the invention, an optical transmitter includes:

a plurality of transmission systems, each made up of a transmission circuit that generates a signal beam, a saturable absorbing optical element having a saturable absorbing region that receives a signal beam generated by the transmission circuit, and an optical mixer that forms the output section of the saturable absorbing optical element, that receives an offset beam generated by the light source, and that outputs the offset beam toward the saturable absorbing optical element;

a light source that generates an offset beam;

an optical dividing means that receives an offset beam generated by the light source, divides the offset beam into a plurality of offset beams, and supplies an offset beam to each of the optical mixers that form a part of the plurality of transmission systems; and

an optical coupler that multiplexes the plurality of signal beams outputted from the plurality of transmission systems.

According to another form of the invention, an optical transmitter includes:

a plurality of transmission systems, each made up of a transmission circuit that generates a signal beam, a first optical mixer that receives a signal beam generated by the transmission circuit and an offset beam and mixes these two beams, a saturable absorbing optical element having a saturable absorbing region that receives the output of the first optical mixer, and a second optical mixer that forms the output section of the saturable absorbing optical element and that receives an offset beam generated by the light source and outputs the offset beam toward the saturable absorbing optical element;

a light source that generates an offset beam; an optical dividing means that receives an offset beam generated by the light source, divides the offset beam into a plurality of offset beams, and supplies an offset beam to each of the first and second optical mixers that form a part of the plurality of transmission systems; and

an optical coupler that multiplexes the plurality of signal beams outputted from the plurality of transmission systems.

In any of the above-described cases, each of the plurality of transmission systems may include a means, provided in a section following the transmission circuit, for transmitting the signal beam outputted by the transmission circuit in only one direction.

In addition, each of the plurality of transmission systems may include a first wavelength selecting means provided as the output section of each transmission system, that does not transmit an offset beam component.

The optical transmitter may further include a first wavelength selecting means that does not transmit an offset beam component for the plurality of signal beams multiplexed by the optical coupler.

The optical transmitter may further include a dispersion compensating means having the function of compensating dispersion for the plurality of signal beams multiplexed by the optical coupler.

Each of the plurality of transmission systems may further include an optical amplifier provided in a section preceding the saturable absorbing optical element, i.e., on the transmission circuit side of the saturable absorbing optical element.

Each of the plurality of transmission systems may further include an optical amplifier provided in a section following the saturable absorbing optical element, i.e., on the transmission line side of the saturable absorbing optical element.

Each of the plurality of transmission systems may further include: a first optical amplifier provided in a section preceding the saturable absorbing optical element, i.e., on the transmission circuit side of the saturable absorbing optical element; and a second optical amplifier provided in a section following the saturable absorbing optical element, i.e., on the transmission line side of the saturable absorbing optical element.

Each of the plurality of transmission systems may include a second wavelength selecting means, provided in the output section of the transmission system, that transmits only the signal beam bandwidth.

Finally, each of the plurality of transmission systems may include a dispersion compensating circuit having the function of compensating dispersion.

A time division multiplex optical transmitter according to the present invention includes:

a plurality of optical transmitters or optical transmission systems constructed as described hereinabove;

a plurality of delay circuits provided in each of a plurality of optical transmitters or optical transmission systems that each give a time difference to an optical signal transmitted to a transmission line; and

an optical coupler that multiplexes each signal beam from the plurality of delay circuits and transmits to a transmission line.

An optical receiver according to the present invention receives a signal beam from a transmission line by means of a reception circuit and includes a saturable absorbing optical element having a saturable absorbing region that receives the signal beam from the transmission line and outputs to a reception circuit. According to another form of the invention, an optical receiver, which receives a signal beam from a transmission line by means of a reception circuit, includes:

a light source that generates an offset beam; an optical mixer that receives a signal beam from the transmission line and an offset beam generated by the light source and mixes these two beams; and

a saturable absorbing optical element having a saturable absorbing region that receives the output of the optical mixer and outputs to a reception circuit.

According to another form of the invention, an optical receiver, which receives a signal beam from a transmission line by means of a reception circuit, includes:

a light source that generates an offset beam; a saturable absorbing optical element having a saturable absorbing region that receives a signal beam from the transmission line; and

an optical mixer that receives an offset beam generated by the light source, outputs the offset beam toward the saturable absorbing optical element, and outputs the output of the saturable absorbing optical element to a reception circuit.

According to another form of the invention, an optical receiver, which receives a signal beam from a transmission line by means of a reception circuit, includes:

a first and second light source that generate a first and second offset beam;

a first optical mixer that receives a signal beam from the transmission line and the first offset beam generated by the first light source and mixes these two beams;

a saturable absorbing optical element having a saturable absorbing region that receives the output of the first optical mixer; and

a second optical mixer that receives the second offset beam generated by the second light source, outputs the offset beam toward the saturable absorbing optical element, and outputs the output of the saturable absorbing optical element to a receptor circuit.

According to another form of the invention, an optical receiver, which receives a signal beam from a transmission line by means of a reception circuit, includes:

a light source that generates an offset beam; an optical dividing means that receives an offset beam generated by the light source, divides the offset beam into first and second offset beams, and outputs the offset beams;

a first optical mixer that receives a signal beam from the transmission line and the first offset beam divided by the optical dividing means and mixes these two beams;

a saturable absorbing optical element having a saturable absorbing region that receives the output of the first optical mixer; and

a second optical mixer that receives the second offset beam divided by the optical dividing means, outputs the second offset beam toward the saturable absorbing optical element, and outputs the output of the saturable absorbing optical element to the reception circuit.

Any of the above-described cases may include a means provided between the transmission line and the saturable absorbing optical element that transmits the signal beam from the transmission line in only the direction toward the reception circuit.

Any of the above-described cases may further include a first wavelength selecting means, provided on the input side of the reception circuit, that does not transmit an offset beam component.

Any of the above-described cases may further include an optical amplifier provided in the section preceding the saturable absorbing optical element, i.e., on the transmission line side of the saturable absorbing optical element.

Each of the above-described cases may further include an optical amplifier provided in the section following the saturable absorbing optical element, i.e., on the reception circuit side of the saturable absorbing optical element.

Each of the above-described cases may further include a first optical amplifier provided in the section preceding the saturable absorbing optical element, i.e., on the transmission line side of the saturable absorbing optical element; and a second optical amplifier provided in the section following the saturable absorbing optical element, i.e., on the reception circuit side of the saturable absorbing optical element.

Each of the above-described cases may further include a second wavelength selecting means provided on the input side of the reception circuit that transmits only the signal beam bandwidth.

Each of the above-described cases may further include a dispersion compensating circuit having the function of compensating dispersion. A wavelength division multiplex optical receiver of the present invention includes:

a plurality of optical receivers constructed as explained in any of the above-described cases that each receive a signal beam of different wavelength; and an optical divider that divides each signal beam from the transmission line and transmits to each optical receiver.

According to another form of the present invention, an optical receiver includes:

a plurality of reception systems, each made up of an optical mixer that receives a signal beam and an offset beam and mixes these two beams, a saturable absorbing optical element having a saturable absorbing region that receives the output of the optical mixer, and a reception circuit that receives the output of the saturable absorbing optical element;

a light source that generates an offset beam;

an optical dividing means that receives an offset beam generated by the light source, divides the offset beam into a plurality of offset beams, and supplies an offset beam to each of the optical mixers forming a part of the plurality of reception systems; and

an optical divider that divides a plurality of signal beams from a transmission line and supplies the divided signal beams as signal beams to the plurality of reception systems.

An optical receiver according to another form of the invention includes:

a plurality of reception systems, each made up of a saturable absorbing optical element having a saturable absorbing region that receives a signal beam, an optical mixer that forms the output section of the saturable absorbing optical element and that receives an offset beam generated by the light source and outputs the offset beam toward the saturable absorbing optical element, and a reception circuit that receives the output of the optical mixer;

a light source that generates an offset beam; an optical dividing means that receives an offset beam generated by the light source, divides the offset beam into a plurality of offset beams, and supplies an offset beam to each of the optical mixers that form a part of the plurality of reception systems; and

an optical divider that divides a plurality of signal beams from a transmission line and supplies the divided signal beams as signal beams to the plurality of reception systems.

An optical receiver according to another form of the invention includes:

a plurality of reception systems each made up of a first optical mixer that receives a signal beam and an offset beam and mixes these two beams, a saturable absorbing optical element having a saturable absorbing region that receives the output of the first optical mixer, a second optical mixer that forms the output section of the saturable absorbing optical element and that receives an offset beam generated by the light source and outputs the offset beam toward the saturable absorbing optical element , and a reception circuit that receives the output of the second optical mixer;

a light source that generates an offset beam;

an optical dividing means that receives an offset beam generated by the light source, divides the offset beam into a plurality of offset beams, and supplies an offset beam to each of the first and second optical mixers that form a part of the plurality of reception systems; and

an optical divider that divides a plurality of signal beams from a transmission line and supplies these divided signal beams as signal beams to the plurality of reception systems.

In this case, each of the plurality of reception systems may further include means for transmitting a signal beam in only the direction of the reception circuit.

Each of the plurality of reception systems may further include a first wavelength selecting means, provided on the input side of the reception circuit, that does not transmit an offset beam component.

The optical receiver may further include a first wavelength selecting means that does not transmit an offset beam component for a plurality of signal beams from a transmission line.

The optical receiver may further include a dispersion compensating circuit having the function of compensating dispersion for a plurality of signal beams multiplexed by an optical coupler.

Each of the plurality of reception systems may further include an optical amplifier provided in the section preceding the saturable absorbing optical element, i.e., on the transmission line side of the saturable absorbing optical element.

Each of the plurality of reception systems may further include an optical amplifier provided in the section following the saturable absorbing optical element, i.e., on the reception circuit side of the saturable absorbing optical element.

Each of the plurality of receptions systems may further include: a first optical amplifier provided in the section preceding the saturable absorbing optical element, i.e., on the transmission line side of the saturable absorbing optical element; and a second optical amplifier provided in the section following the saturable absorbing optical element, i.e., on the reception circuit side of the saturable absorbing optical element.

Each of the plurality of reception systems may further include a second wavelength selecting means that transmits only the signal beam bandwidth.

Each of the plurality of reception systems may further include a dispersion compensating circuit having the function of compensating dispersion.

A time division multiplex optical receiver of the present invention includes:

a plurality of optical receivers constructed as described hereinabove;

a plurality of delay circuits provided for each of the plurality of optical receivers that each give a time difference to received signal beams; and

an optical divider that divides signal beams from a transmission line and transmits to each of the optical receivers.

An optical transmission system of the present invention is constituted by using any of the above-described optical receivers, wavelength division multiplex optical receivers, time division multiplex optical receivers, optical transmitters, wavelength division multiplex optical transmitters, or time division multiplex optical transmitters.

In the invention constructed according to the foregoing explanation, the signal-to-noise ratio of a signal beam can be improved through the use of a saturable absorbing optical element. A saturable absorbing optical element absorbs (an input signal beam) if the output intensity of the input signal beam to the saturable absorbing optical element is below a particular value (threshold) and allows the input signal beam to pass if the output intensity of the input signal beam is above a particular value (threshold). The regulation of a signal beam by using, for example, an offset beam, such that the low-level intensity is below the threshold value and the high-level intensity is above the threshold value therefore enables suppression of optical noise and improvement of the signal-to-noise ratio.

The above and other objects, features, and advantages of the invention will become apparent from the following description with reference to the accompanying drawings which illustrate examples of the present invention.

### BRIEF DESCRIPTION OF THE DRAWINGS

FIG. 1 is an explanatory view of the configuration of an optical transmitter as the first embodiment of the present invention, FIG. 1(a) being a block diagram showing the configuration of optical transmitter 1 that sends a signal beam to transmission line 2, and FIGS. 1(b) and 1(c) are explanatory views showing the working of saturable absorbing optical element 3 provided in the optical transmitter 1.

FIG. 2(a) and FIG. 2(b) show the characteristic of saturable absorbing optical element 3 shown in FIG. 1.

FIG. 3 is a block diagram showing the configuration of the second embodiment of the invention.

FIG. 4 is a block diagram showing the configuration of the third embodiment of the invention.

FIG. 5 is a block diagram showing the configuration of the fourth embodiment of the invention.

FIG. 6 is a block diagram showing the configuration of the fifth embodiment of the invention.

FIG. 7 is a block diagram showing the configuration of the sixth embodiment of the invention.

FIG. 8 is a block diagram showing the configuration of the seventh embodiment of the invention.

FIG. 9 is a block diagram showing the configuration of the eighth embodiment of the invention.

FIG. 10 is a block diagram showing the configuration of the ninth embodiment of the invention.

FIG. 11 is a block diagram showing the configuration of the tenth embodiment of the invention.

FIG. 12 is a block diagram showing the configuration of the eleventh embodiment of the invention.

FIG. 13 is a block diagram showing the configuration of the twelfth embodiment of the invention.

FIG. 14 is a block diagram showing the configuration of the thirteenth embodiment of the invention.

FIG. 15 is a block diagram showing the configuration of the fourteenth embodiment of the invention.

FIG. 16 is a block diagram showing the configuration of the fifteenth embodiment of the invention.

FIG. 17 is a block diagram showing the configuration of the sixteenth embodiment of the invention.

FIG. 18 is a block diagram showing the configuration of the seventeenth embodiment of the invention.

FIG. 19 is a block diagram showing the configuration of the eighteenth embodiment of the invention.

FIG. 20 is a block diagram showing the configuration of the nineteenth embodiment of the invention.

FIG. 21 is a block diagram showing the configuration of the twentieth embodiment of the invention.

FIG. 22 is a block diagram showing the configuration of the twenty-first embodiment of the invention.

FIG. 23 is a block diagram showing the configuration of the twenty-second embodiment of the invention.

FIG. 24 is a block diagram showing the configuration of the twenty-third embodiment of the invention.

FIG. 25 is an explanatory view of the twenty-fourth embodiment of the present invention, FIG. 25(a) being a block diagram showing the configuration of optical receiver 101 that sends a signal beam to reception circuit 102, and FIG. 25(b) and FIG. 25(c) being explanatory views showing the working of saturable absorbing optical element 103 provided in optical receiver 101.

FIG. 26 is a block diagram showing the configuration of the twenty-fifth embodiment of the invention.

FIG. 27 is a block diagram showing the configuration of the twenty-sixth embodiment of the invention.

FIG. 28 is a block diagram showing the configuration of the twenty-seventh embodiment of the invention.

FIG. 29 is a block diagram showing the configuration of the twenty-eighth embodiment of the invention.

FIG. 30 is a block diagram showing the configuration of the twenty-ninth embodiment of the invention.

FIG. 31 is a block diagram showing the configuration of the thirtieth embodiment of the invention.

FIG. 32 is a block diagram showing the configuration of the thirty-first embodiment of the invention.

FIG. 33 is a block diagram showing the configuration of the thirty-second embodiment of the invention.

FIG. 34 is a block diagram showing the configuration of the thirty-third embodiment of the invention.

FIG. 35 is a block diagram showing the configuration of the thirty-fourth embodiment of the invention.

FIG. 36 is a block diagram showing the configuration of the thirty-fifth embodiment of the invention.

FIG. 37 is a block diagram showing the configuration of the thirty-sixth embodiment of the invention.

FIG. 38 is a block diagram showing the configuration of the thirty-seventh embodiment of the invention.

FIG. 39 is a block diagram showing the configuration of the thirty-eighth embodiment of the invention.

FIG. 40 is a block diagram showing the configuration of the thirty-ninth embodiment of the invention.

FIG. 41 is a block diagram showing the configuration of the fortieth embodiment of the invention.

FIG. 42 is a block diagram showing the configuration of the forty-first embodiment of the invention.

FIG. 43 is a block diagram showing the configuration of the forty-second embodiment of the invention.

FIG. 44 is a block diagram showing the configuration of the forty-third embodiment of the invention.

FIG. 45 is a block diagram showing the configuration of the forty-fourth embodiment of the invention.

FIG. 46 is a block diagram showing the configuration of the forty-fifth embodiment of the invention.

FIG. 47 is a block diagram showing the configuration of the forty-sixth embodiment of the invention.

FIG. 48 is a block diagram showing the configuration of the forty-seventh embodiment of the invention.

FIG. 49 is a block diagram showing the configuration of the forty-eighth embodiment of the invention.

FIG. 50 is a block diagram showing the configuration of the forty-ninth embodiment of the invention.

### DETAILED DESCRIPTION OF THE PREFERRED EMBODIMENTS

Explanation of the embodiments of the invention is next presented with reference to the accompanying figures.

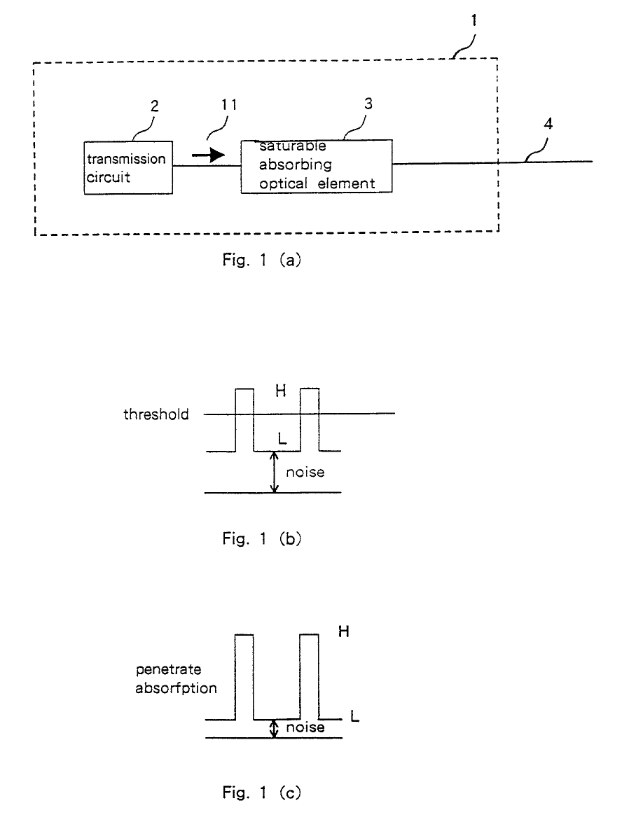

FIG. 1 is an explanatory view showing the configuration of an optical transmitter as the first embodiment of the invention, FIG. 1(a) being a block diagram showing the configuration of optical transmitter 1 that transmits a signal beam to transmission line 4, and FIG. 1(b) and FIG. 1(c) being explanatory views showing the operation of saturable absorbing optical element 3 provided in optical transmitter 1.

In optical transmitter 1, signal beam 11 sent from transmission circuit 2 is sent by way of saturable absorbing optical element 3 to transmission line 4. Saturable absorbing optical element 3 is provided to block optical noise contained in received signal beam 11. Saturable absorbing optical element 3, which can also be called an optical gate, has a saturable absorbing effect that results from applying a reverse bias voltage to a semiconductor waveguide, and has a nonlinear transmission characteristic that is dependent on the input light intensity. In other words, this optical element has a characteristic such that a data pulse of high light intensity exceeds (saturates) the absorption capacity of the optical element and is transmitted, but a noise component of low light intensity is strongly absorbed and thus reduced. A pulse waveform containing a noise component and having a peak value that exceeds the threshold of the transmission characteristic and absorption characteristic as shown in FIG. 1(b) can thus be made a pulse waveform with reduced noise component as shown in FIG. 1(c).

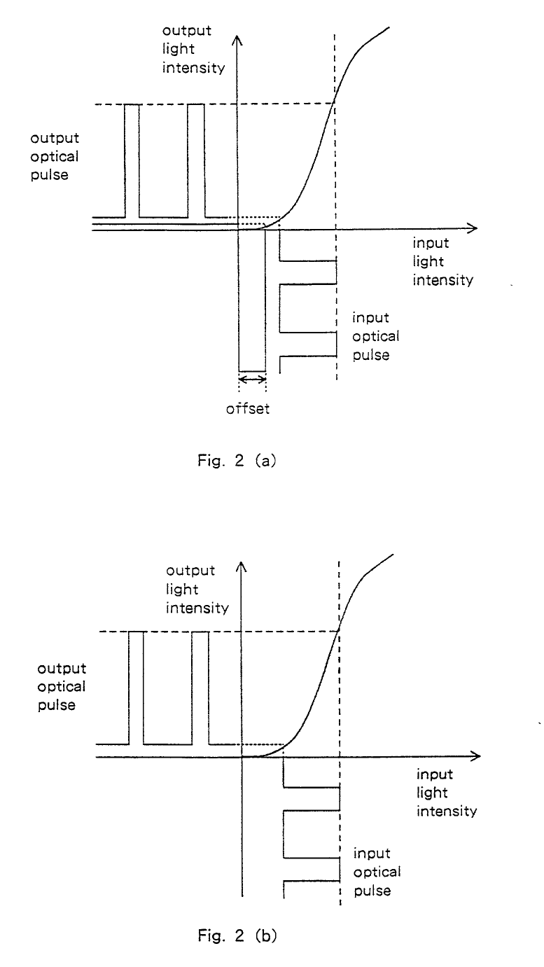

FIG. 2(a) and FIG. 2(b) show the characteristics of saturable absorbing optical element 3, and the operation of this embodiment is explained below with reference to FIG. 1 and FIG. 2.

In FIG. 1, signal beam 11 is received in saturable absorbing optical element 3 from transmission circuit 2 . Saturable absorbing optical element 3 is provided with a nonlinear transmission characteristic that is dependent on the input light intensity as shown in FIG. 2(a) and FIG. 2(b), and thus has a characteristic such that a data pulse of high light intensity exceeds (saturates) the absorption capacity of the optical element and is transmitted, but a pulse of low light intensity is strongly absorbed and reduced. In other words, the signal beam outputted from saturable absorbing optical element 3 has suppressed optical noise and an improved signal-to-noise ratio, and this signal beam is outputted to transmission line 4. FIG. 2(a) shows a case in which an offset beam is used, and FIG. 2(b) shows a case in which an offset beam is not used. In a case in which the peak value of an input beam is not sufficiently greater than the threshold shown in FIG. 1(b) and a sufficient output optical pulse cannot be obtained, addition of an offset beam as shown in FIG. 2(a) enables an adequate output optical pulse.

FIG. 3 is a block diagram showing the configuration of the second embodiment of the invention.

This embodiment provides the first embodiment shown in FIG. 1 with light source 5 that generates offset beam 12, and optical mixer 6 that mixes signal beam 11 sent from transmission circuit 2 and offset beam 12 sent from light source 5 and outputs the resulting beam to saturable absorbing optical element 3. Signal beam 11 sent from transmission circuit 2 is mixed with offset beam 12 from light source 5 by means of optical mixer 6 and then applied to saturable absorbing optical element 3. In this case, optical mixer 6 is arranged in the section preceding saturable absorbing optical element 3 with respect to signal beam 11.

To explain the offset beam again in greater detail, saturable absorbing optical element 3 is provided with a nonlinear transmission characteristic that is dependent on the input light intensity as shown in FIG. 2(a) and FIG. 2(b), such that a data pulse of high light intensity exceeds (saturates) the absorption capacity of the optical element and is transmitted, but a pulse of low light intensity is strongly absorbed and reduced. This characteristic is dependent on the total input light intensity applied to saturable absorbing optical element 3. Particularly in a case in which the light intensity of the signal beam itself is low, a continuous beam of higher intensity or an optical pulse synchronized to the signal beam must be applied from the outside as an offset beam for the transmission characteristic of saturable absorbing optical element 3 to increase the total light intensity applied to saturable absorbing optical element 3. This embodiment is intended for a case in which the intensity of a signal beam itself is low as described hereinabove, and by means of the above-described configuration, the signal beam outputted from saturable absorbing optical element 3 has suppressed optical noise and improved signal-to-noise ratio and is outputted to transmission line 4.

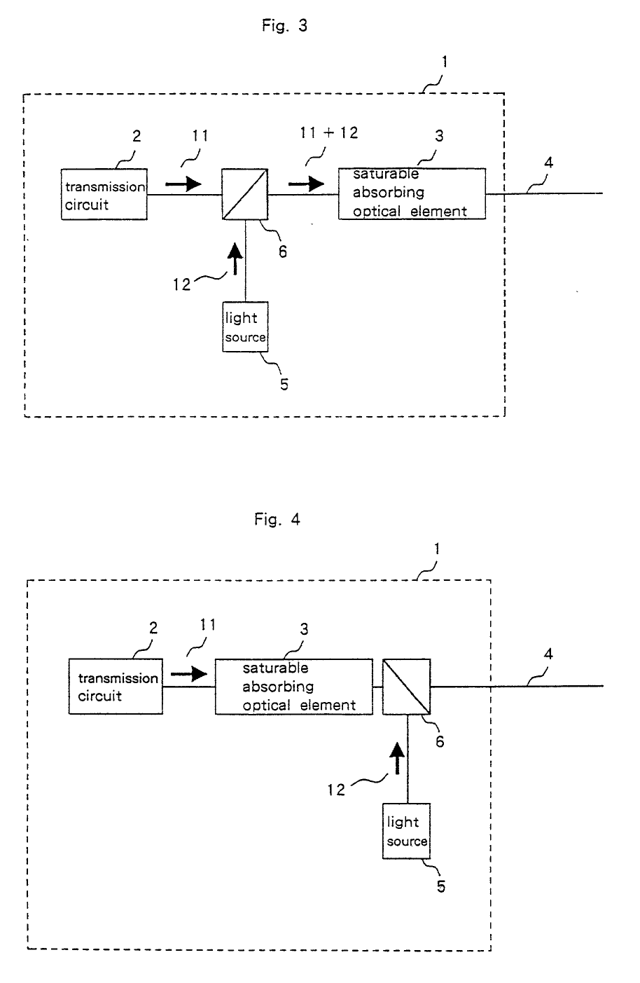

FIG. 4 is a block diagram showing the configuration of the third embodiment of the invention.

This embodiment provides the first embodiment shown in FIG. 1 with light source 5 that generates offset beam 12, and optical mixer 6 that mixes the output of saturable absorbing optical element 3 with offset beam 12 sent from light source 5 and outputs the result to transmission line 4. Signal beam 11 sent from transmission circuit 2 is applied to optical mixer 6 by way of saturable absorbing optical element 3, offset beam 12 from light source 5 is applied to optical mixer 6, the two beams are mixed, and the result is sent to transmission line 4. In this case, optical mixer 6 is arranged in the section following saturable absorbing optical element 3 with respect to signal beam 11.

Optical mixer 6 is arranged such that received offset beam 12 is outputted toward saturable absorbing optical element 3, and this embodiment features the same operation and effect as the second embodiment shown in FIG. 3.

Optical mixer 6 used in either the second or third embodiment of the invention is arranged such that the received offset beam is applied to saturable absorbing optical element 3, and each of the embodiments described hereinbelow are equivalent.

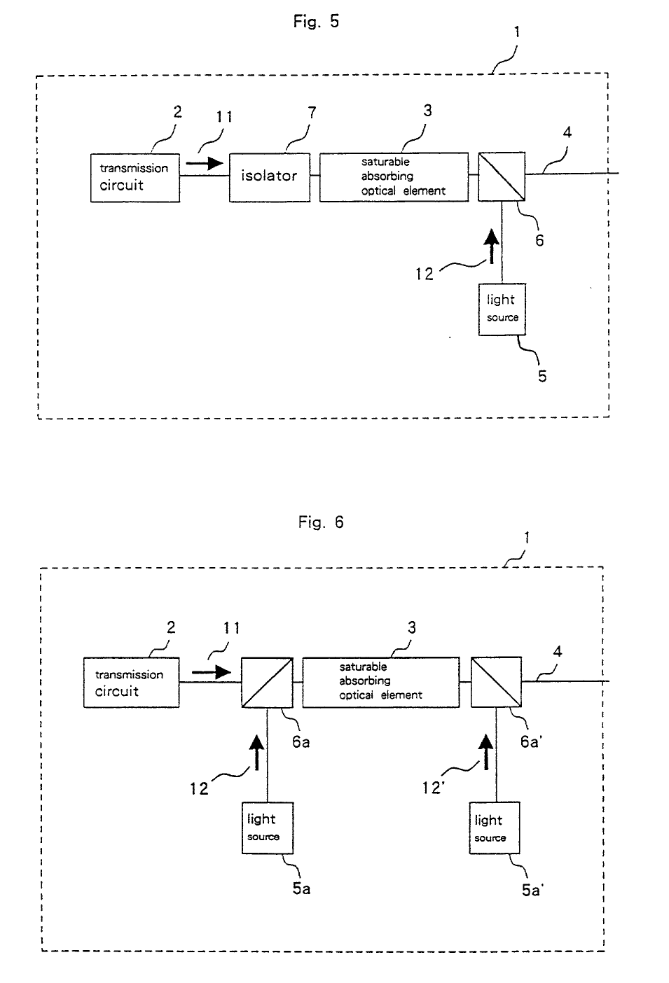

FIG. 5 is a block diagram showing the configuration of the fourth embodiment of the invention. In this embodiment, isolator 7, which is a means for transmitting light in only one direction, is inserted on the output side of transmission circuit 2 of the third embodiment shown in FIG. 4.

The provision of isolator 7 in this embodiment prevents the input of offset beam 12 generated by light source 5 into transmission circuit 2, and prevents unstable operation in transmission circuit 2.

FIG. 6 is a block diagram showing the configuration of the fifth embodiment of the invention.

In this embodiment, the first embodiment shown in FIG. 1 is further provided with light sources 5a and 5a′ that generate offset beams 12 and 12′, optical mixer 6a that mixes the output of transmission circuit 2 and offset beam 12 sent in from light source 5a and outputs the combined beam to saturable absorbing optical element 3, and optical mixer 6a′ that mixes the output of saturable absorbing optical element 3 and offset beam 12′ sent in from light source 5a′ and outputs to transmission line 4. Signal beam 11 sent from transmission circuit 2 is mixed with offset beam 12 from light source 5a by means of optical mixer 6a and applied to saturable absorbing optical element 3. The output of saturable absorbing optical element 3 is mixed with offset beam 12′ from light source 5a′ by means of optical mixer 6a′ and sent to transmission line 4. In this case, optical mixers 6a and 6a′ are respectively arranged in the sections preceding and following saturable absorbing optical element 3 with respect to signal beam 11.

The embodiment configured as described hereinabove features the combined effects of the second and third embodiments.

In the configuration shown in FIG. 6, optical mixers 6a and 6a′ each receive offset beams 12 and 12′ generated by different light sources 5a and 5a′, but a configuration may also be adopted in which the optical mixers receive beams produced by dividing, by means of an optical divider, an offset beam generated by one light source.

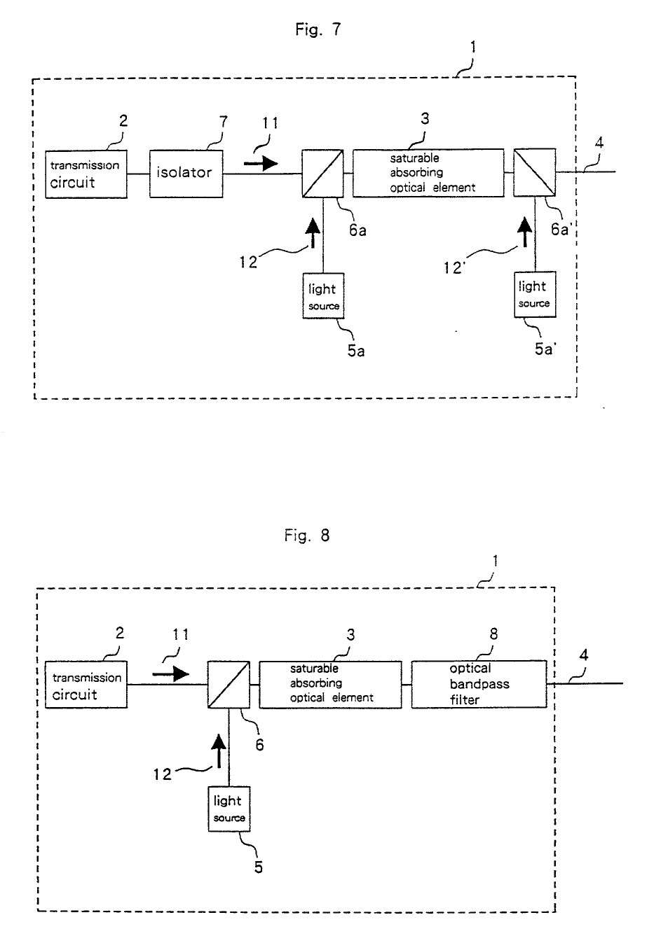

FIG. 7 is a block diagram showing the configuration of the sixth embodiment of the invention.

In this embodiment, isolator 7, which is a means of transmitting light in only one direction, is inserted in the output side of transmission circuit 2 in the fifth embodiment shown in FIG. 6.

In addition to the effect of the fifth embodiment, the provision of isolator 7 in this embodiment prevents the input of offset beam 12 generated by light source 5a into transmission circuit 2 and therefore prevents unstable operation in transmission circuit 2.

FIG. 8 is a block diagram showing the configuration of the seventh embodiment of the invention.

In this embodiment, optical bandpass filter 8 such as a fiber grating is inserted in the section following saturable absorbing optical element 3 in the second embodiment shown in FIG. 3. Optical bandpass filter 8 is for extracting only the signal beam wavelength component and has a characteristic such that only the bandwidth of the signal beam is transmitted and bandwidths other than that of the signal beam are blocked. The signal beam is therefore outputted to transmission line 4 after eliminating the component of offset beam 12 by means of optical bandpass filter 8.

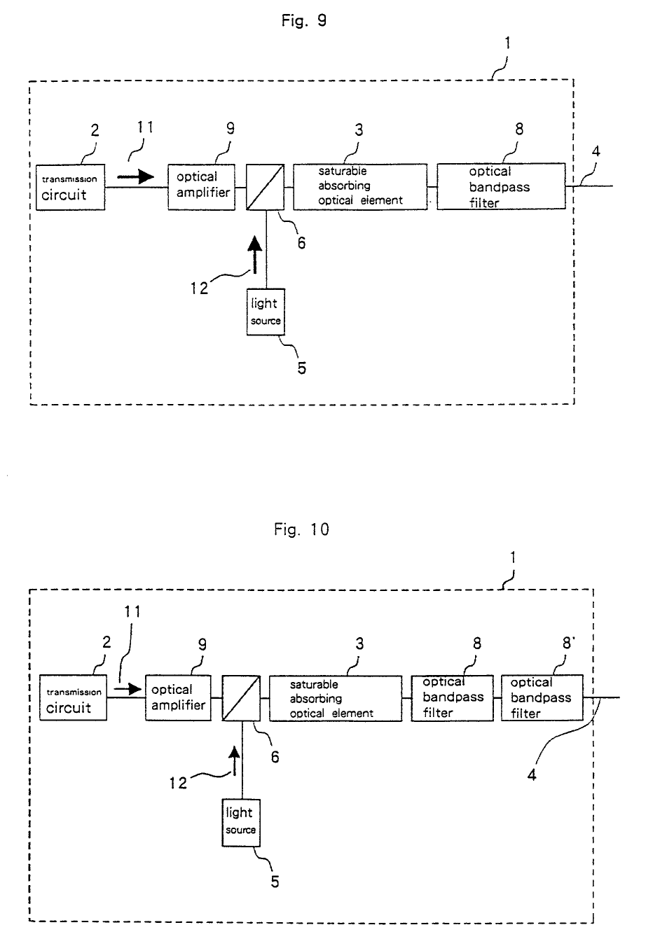

FIG. 9 is a block diagram showing the configuration of the eighth embodiment of the invention.

In this embodiment, optical amplifier 9 is inserted in the section preceding saturable absorbing optical element 3 of the seventh embodiment shown in FIG. 8. Optical amplifier 9 is controlled by, for example, a constant-output control method. The regulation of the output of optical amplifier 9 in accordance with the transmission characteristic of saturable absorbing optical element 3 therefore allows the optical noise to be effectively suppressed and the signal-to-noise ratio of the signal beam to be effectively improved.

FIG. 10 is a block diagram showing the configuration of the ninth embodiment of the invention.

In this embodiment, optical bandpass filter 8′ such as a fiber grating is inserted in the section following optical bandpass filter 8 in the eighth embodiment shown in FIG. 9. Optical bandpass filter 8′ is for extracting only the signal beam wavelength component and has a characteristic such that allows only the bandwidth of the signal beam is transmitted and bandwidths other than that of the signal beam are blocked. The signal beam is therefore outputted to transmission line 4 after eliminating the component of offset beam 12 by means of optical bandpass filter 8 and allowing only the signal beam bandwidth to pass by means of optical bandpass filter 8′.

In this embodiment, the signal-to-noise ratio of the signal beam outputted to transmission line 4 is further improved by providing a two-stage configuration of optical bandpass filters.

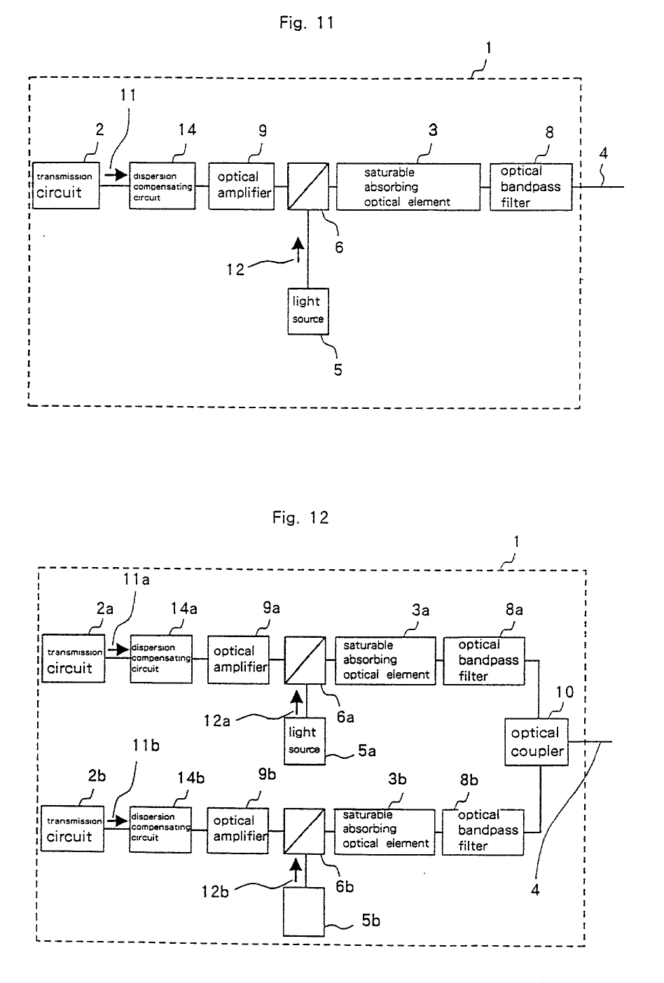

FIG. 11 is a block diagram showing the configuration of the tenth embodiment of the invention.

In this embodiment, dispersion compensating circuit 14 having the function of compensating for dispersion in transmission line 4 is provided between transmission circuit 2 and optical amplifier 9 of the eighth embodiment shown in FIG. 9. This embodiment enables a reduction of the effect of dispersion in transmission line 4.

FIG. 12 is a block diagram showing the eleventh embodiment of the invention.

This embodiment employs two sets of the construction of the tenth embodiment shown in FIG. 11, the signal beam outputted by each set being multiplexed by optical coupler 10. In FIG. 12, the letter “a” identifies components of one set and the letter “b” identifies components of the other set. The same notation is used hereinbelow for other embodiments in which multiplexing is applied. This embodiment enables wavelength division multiplex transmission, and therefore allows an increase in the transmission volume.

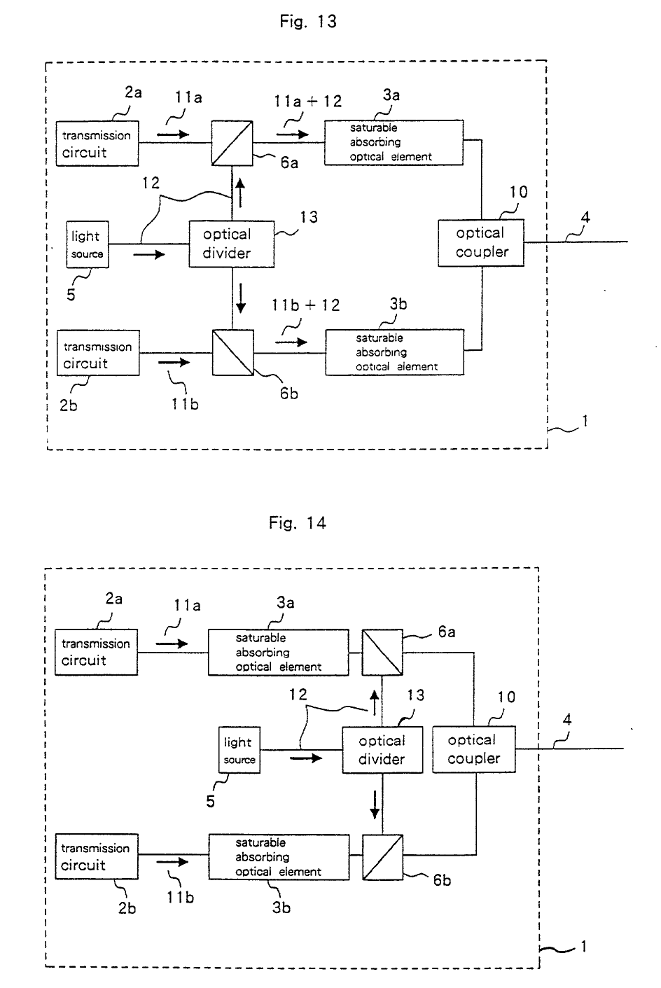

FIG. 13 is a block diagram showing the configuration of the twelfth embodiment of the invention.

This embodiment is intended for wavelength division multiplex transmission by employing two sets of the construction equivalent to the second embodiment shown in FIG. 3, and in addition, seeks a simplification of the device structure by sharing the light source that generates an offset beam.

Signal beam 11a outputted by transmission circuit 2a is applied to optical mixer 6a, mixed with offset beam 12 that is generated by light source 5 and divided by optical divider 13, applied with offset beam 12 to saturable absorbing optical element 3a to be converted to a pulse waveform having a reduced noise component, and then applied to optical coupler 10. Signal beam 11b outputted by transmission circuit 2b is applied to optical mixer 6b, mixed with offset beam 12 that is generated by light source 5 and divided by optical divider 13, applied with offset beam 12 to saturable absorbing optical element 3b to be converted to a pulse waveform having a reduced noise component, and then applied to optical coupler 10. The two inputs are multiplexed in optical coupler 10 and outputted to transmission line 4.

In the embodiment configured as described above, the use of optical divider 13 for sharing offset beam 12 between two different saturable absorbing optical elements 3a and 3b enables a reduction of the number of light sources for generating offset beams to each saturable absorbing optical element, thereby allowing a more compact construction and lower costs.

FIG. 14 is a block diagram showing the configuration of the thirteenth embodiment of the invention.

This embodiment is intended for wavelength division multiplex optical transmission by using two sets of a construction equivalent to that of the third embodiment shown in FIG. 4, and in addition, seeks to simplify the device structure by sharing the light source that generates the offset beams.

Signal beam 11a outputted by transmission circuit 2a is applied to saturable absorbing optical element 3a to be converted to a pulse waveform with a reduced noise component, following which it is applied to optical mixer 6a, mixed with offset beam 12 that is generated by light source 5 and divided by optical divider 13, and then applied to optical coupler 10. Signal beam 11b outputted by transmission circuit 2b is applied to saturable absorbing optical element 3b to be converted to a pulse waveform with a reduced noise component, following which it is applied to optical mixer 6b, mixed with offset beam 12 that is generated by light source 5 and divided by optical divider 13, and then applied to optical coupler 10. The two inputs are multiplexed at optical coupler 10 and outputted to transmission line 4. In the embodiment configured as described above, the use of optical divider 13 for sharing offset beam 12 between two different saturable absorbing optical elements 3a and 3b enables a reduction of the number of light sources for generating offset beams to each saturable absorbing optical element, thereby allowing a more compact construction and lower costs.

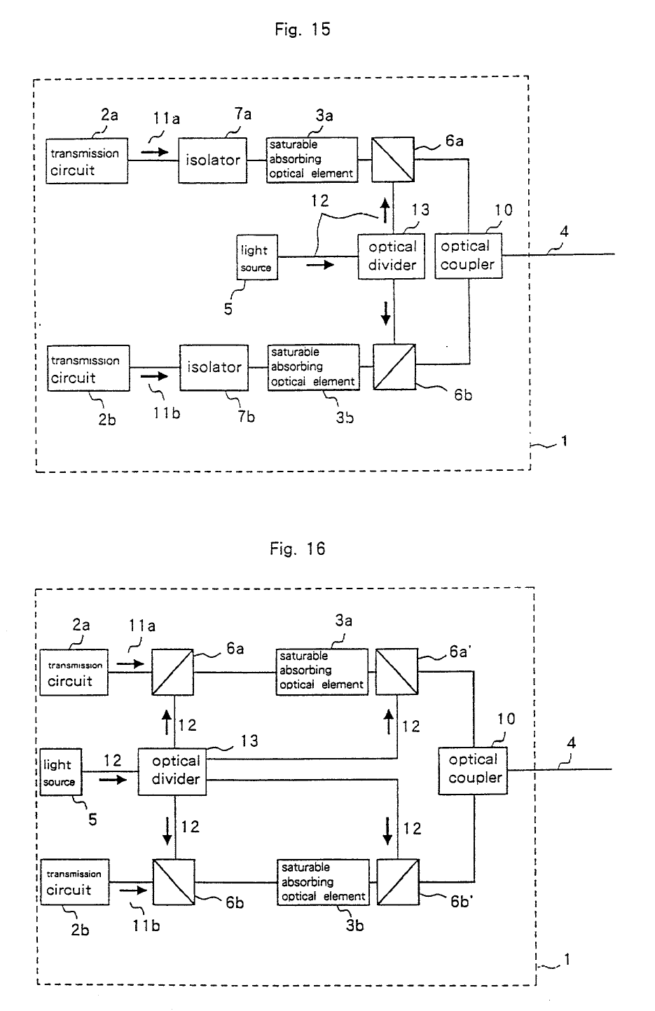

FIG. 15 is a block diagram showing the configuration of the fourteenth embodiment of the invention.

In this embodiment, isolators 7a, and 7b, which are means for transmitting light in only one direction, are inserted in the output side of each of transmission circuits 2a and 2b in the thirteenth embodiment shown in FIG. 14.

In addition to the effect of the thirteenth embodiment, the provision of isolators 7a and 7b in this embodiment prevents the input of offset beam 12 that is generated by light source 5 to transmission circuits 2a and 2b, and thus prevents the unstable operation of transmission circuits 2a and 2b.

FIG. 16 is a block diagram showing the configuration of the fifteenth embodiment of the invention.

This embodiment is intended for wavelength division multiplex transmission by using two sets of the construction equivalent to that of the fifth embodiment shown in FIG. 6, and in addition seeks to simplify of the device structure by sharing the light source that generates an offset beam.

Signal beam 11a outputted from transmission circuit 2a is mixed by means of optical mixer 6a with offset beam 12 that is generated by light source 5 and divided by optical divider 13, and applied with offset beam 12 to saturable absorbing optical element 3a. The output of saturable absorbing optical element 3a is mixed by means of optical mixer 6a′ with offset beam 12 that is generated by light source 5 and divided by optical divider 13, and then sent to transmission line 4. In this case, optical mixers 6a and 6a′ are arranged in the sections preceding and following saturable absorbing optical element 3a with respect to signal beam 11a. Signal beam 11b transmitted from transmission circuit 2b is mixed by means of optical mixer 6b with offset beam 12 that is generated by light source 5 and divided by optical divider 13, and applied with offset beam 12 to saturable absorbing optical element 3b. The output of saturable absorbing optical element 3b is mixed by means of optical mixer 6b′ with offset beam 12 that is generated by light source 5 and divided by optical divider 13, and then sent to transmission line 4. In this case, optical mixers 6b and 6b′ are arranged in the sections preceding and following saturable absorbing optical element 3b with respect to signal beam 11b. In the embodiment configured as described above, the use of optical divider 13 for sharing offset beam 12 among four different optical mixers 6a, 6a′, 6b, and 6b′ enables a reduction of the number of light sources for generating offset beams to each saturable absorbing optical element, thereby allowing a more compact construction and lower costs.

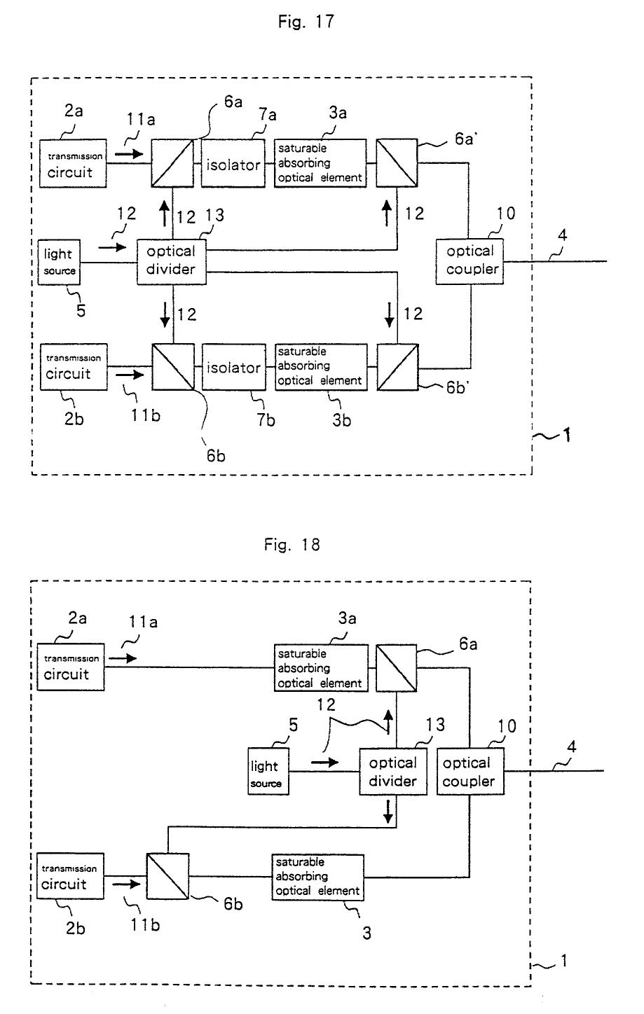

FIG. 17 is a block diagram showing the invention.

In this embodiment, isolators 7a and 7b, which are means for transmitting light in only one direction, are inserted in the output side of each of transmission circuits 2a and 2b in the fifteenth embodiment shown in FIG. 16.

In addition to the effect of the fifteenth embodiment, the provision of isolators 7a and 7b in this embodiment prevents the input of offset beam 12 generated by light source 5 to transmission circuits 2a and 2b, and therefore prevents the unstable operation of transmission circuit 2a and 2b.

FIG. 18 is a block diagram showing the configuration of the seventeenth embodiment of the invention.

This embodiment is intended for wavelength division multiplex optical transmission by using, two sets of transmission systems that include transmission circuits, and also seeks a simplification of the device structure by sharing the light source that generates the offset beam.

Signal beam 11a that is outputted by transmission circuit 2a is applied to saturable absorbing optical element 3a to be converted to a pulse waveform having a reduced noise component, applied to optical mixer 6a and mixed with offset beam 12 that is generated by light source 5 and divided by optical divider 13, and then applied to optical coupler 10. Signal beam 11b that is outputted by transmission circuit 2b is applied to optical mixer 6b, mixed with offset beam 12 that is generated by light source 5 and divided by optical divider 13, applied to saturable absorbing optical element 3b to be converted to a pulse waveform having a reduced noise component, and then applied to optical coupler 10. The two inputs are multiplexed at optical coupler 10 and outputted to transmission line 4. In the embodiment configured as described above, the use of optical divider 13 for sharing offset beam 12 between two different saturable absorbing optical elements 3a and 3b enables a reduction of the number of light sources for generating offset beams to each saturable absorbing optical element, thereby allowing a more compact construction and lower costs.

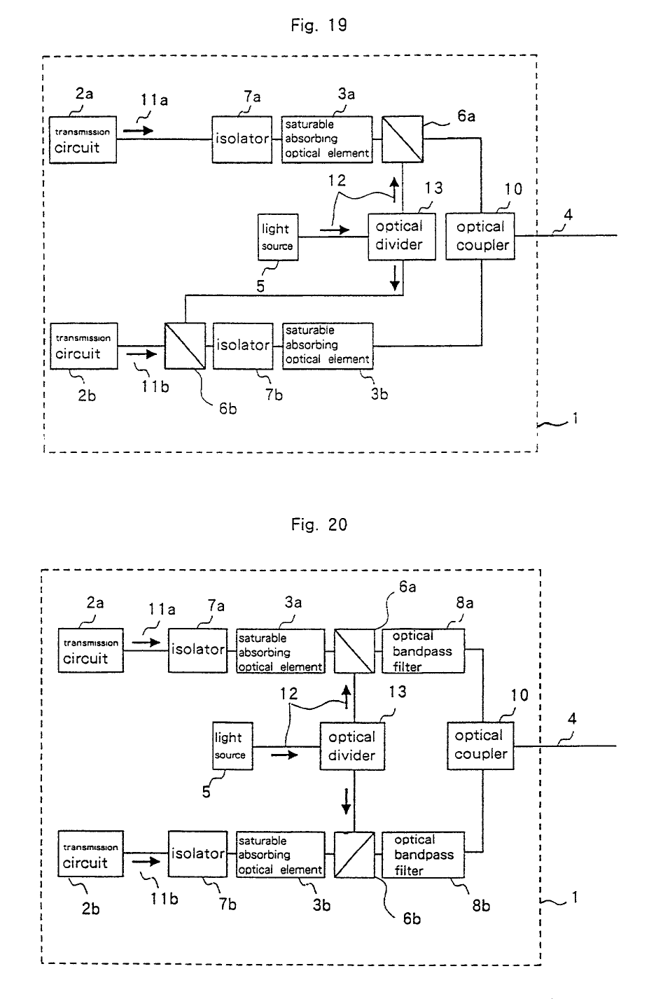

FIG. 19 is a block diagram showing the configuration of the eighteenth embodiment of the invention.

In this embodiment, isolators 7a and 7b, which are means for transmitting light in only one direction, are inserted in the output side of each of transmission circuit 2a and optical mixer 6b in the seventeenth embodiment shown in FIG. 18.

In addition to the effect of the seventeenth embodiment, the provision of isolators 7a and 7b in this embodiment prevents the input of offset beam 12 generated by light source 5 to transmission circuits 2a and 2b, and therefore prevents the unstable operation of transmission circuit 2a and 2b.

FIG. 20 is a block diagram showing the configuration of the nineteenth embodiment of the invention.

In this embodiment, optical bandpass filters 8a and 8b such as a fiber grating are inserted in the sections following optical mixers 6a and 6b in the fourteenth embodiment shown in FIG. 15. Optical bandpass filters 8a and 8b are provided to eliminate offset beam 12 and have a characteristic such that the wavelength bandwidth of offset beam 12 is not transmitted, and the signal beam is thus outputted to transmission line 4 with the offset beam 12 component eliminated by optical bandpass filters 8a and 8b.

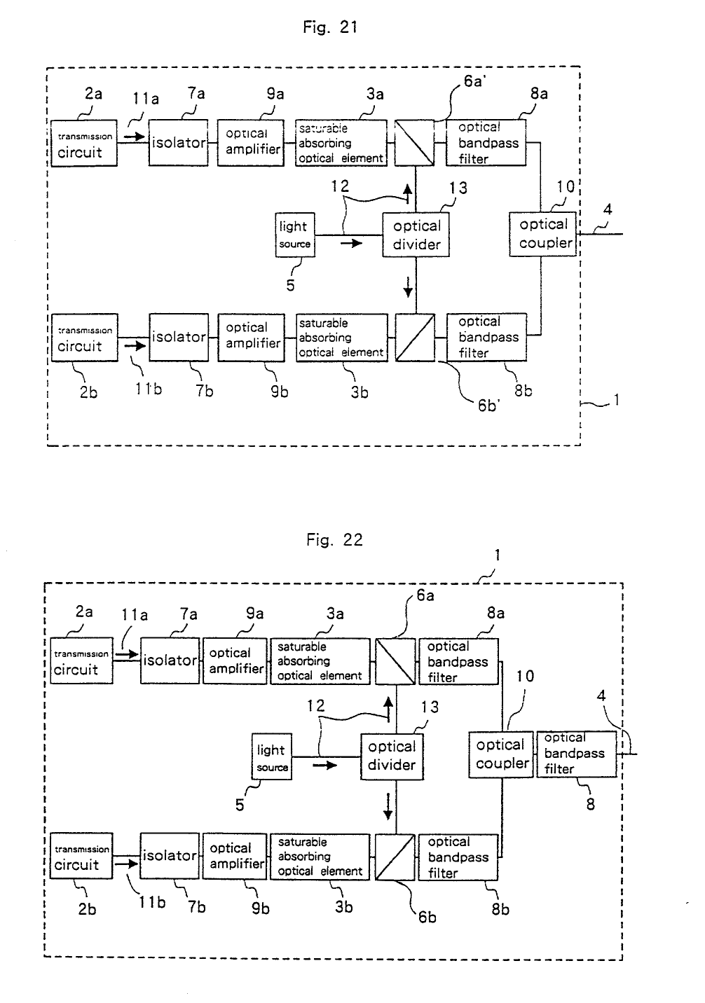

FIG. 21 is a block diagram showing the configuration of the twentieth embodiment of the invention.

In this embodiment, optical amplifiers 9a and 9b are inserted in the sections preceding saturable absorbing optical elements 3a and 3b in the nineteenth embodiment shown in FIG. 20. Optical amplifiers 9a and 9b are controlled by, for example, a constant-output control method. The regulation of the output of optical amplifiers 9a and 9b in accordance with the transmission characteristic of saturable absorbing optical elements 3a and 3b therefore allows optical noise to be effectively suppressed and the signal-to-noise ratio of the signal beam to be effectively improved.

FIG. 22 is a block diagram showing the configuration of the twenty-first embodiment of the invention.

In this embodiment, optical bandpass filter 8 such as a fiber grating is inserted in the section following optical coupler 10 in the twentieth embodiment shown in FIG. 21.

Optical bandpass filter 8 is provided for extracting only the signal beam wavelength component, and therefore has a characteristic such that only the signal beam bandwidth is allowed to pass and bandwidths other than that of the signal beam are blocked. The signal beam is therefore outputted to transmission line 4 with the offset beam 12 component eliminated by optical bandpass filters 8a and 8b, and only the signal beam bandwidth transmitted by optical bandpass filter 8.

This embodiment allows a further improvement of the signal-to-noise ratio by adopting a two-stage configuration of optical bandpass filters.

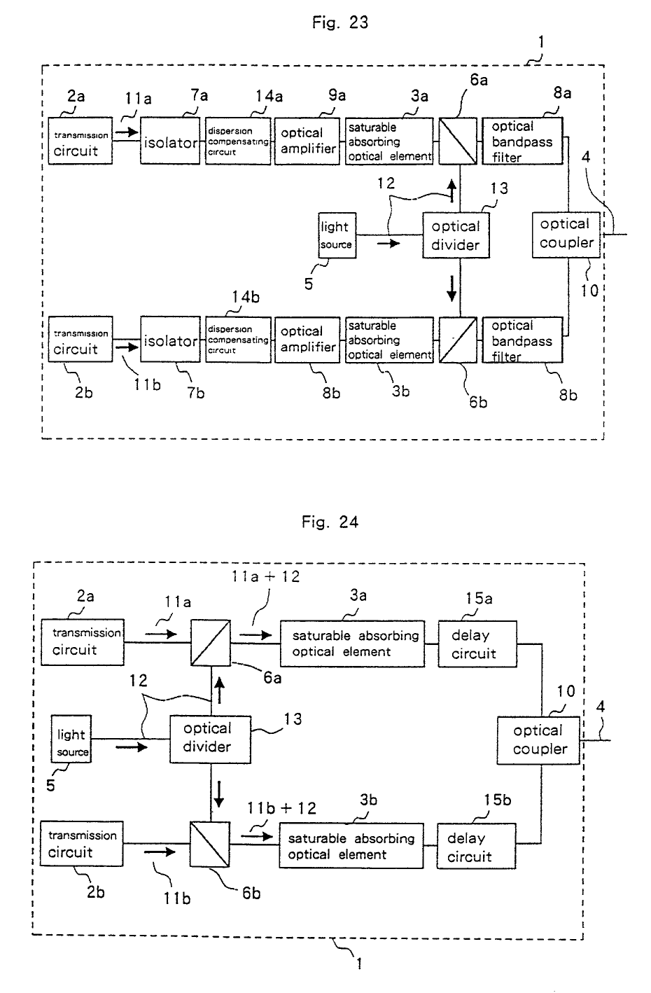

FIG. 23 is a block diagram showing the configuration of the twenty-second embodiment of the invention.

In this embodiment, dispersion compensating circuits 14a and 14b having the function of compensating dispersion in transmission line 4 are provided in the sections preceding optical amplifiers 9a and 9b of the twentieth embodiment shown in FIG. 21. In addition to the effect of the twentieth embodiment, this embodiment enables a reduction of the effect of dispersion in transmission line 4.

FIG. 24 is a block diagram showing the configuration of the twenty-third embodiment of the invention.

In this embodiment, delay circuits 15a and 15b, which delay an input signal by a prescribed time interval and then output the signal, are inserted between optical coupler 10 and each of saturable absorbing optical elements 3a and 3b in the twelfth embodiment shown in FIG. 13. In this embodiment, the output signals of saturable absorbing optical elements 3a and 3b are given a time differential by delay circuits 15a and 15b and then multiplexed by optical coupler 10, thereby enabling time division multiplex transmission.

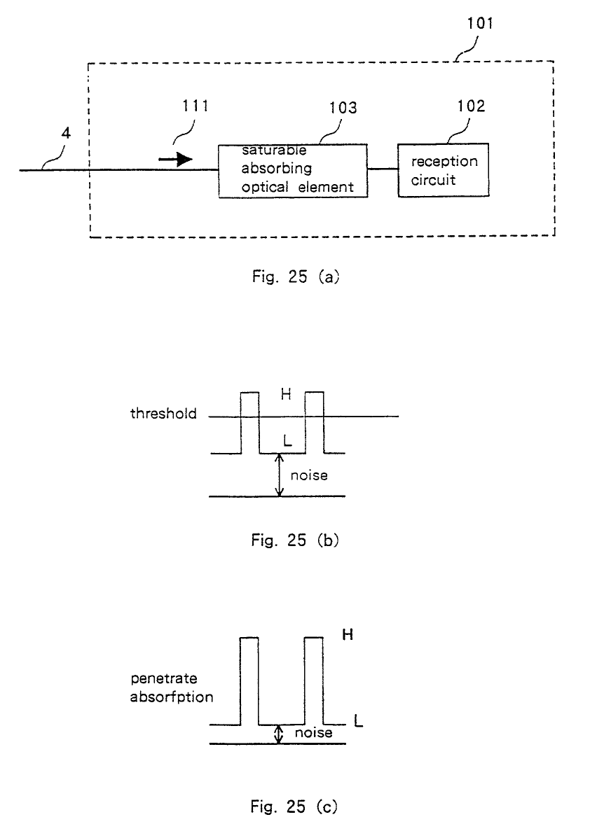

FIG. 25 is an explanatory view showing the configuration of an optical receiver as the twenty-fourth embodiment of the invention, FIG. 25(a) being a block diagram showing the configuration of optical receiver 101, that sends a signal beam to reception circuit 102, FIG. 25(b) and 25(c) being views for illustrating the working of saturable absorbing optical element 103 provided in optical receiver 101.

In optical receiver 101, signal beam 111 sent from transmission line 104 is sent by way of saturable absorbing optical element 103 to reception circuit 102. Saturable absorbing optical element 103 is provided for suppressing the optical noise contained in received signal beam 111. Saturable absorbing optical element 103, which is also referred to as an “optical gate,” has a saturable absorbing effect that results from the application of reverse bias voltage to a semiconductor waveguide, and has a nonlinear transmission characteristic that is dependent on the received light intensity. In other words, the optical element has a characteristic such that a data pulse of high light intensity exceeds (saturates) the absorption capacity of the optical element and is transmitted, but a noise component of low light intensity is strongly absorbed and reduced. As a result, a pulse waveform containing a noise component and having a peak value that exceeds the threshold of the transmission characteristic and absorption characteristic as shown in FIG. 25(b) can be converted to a pulse waveform with a reduced noise component as shown in FIG. 25 (c).

Saturable absorbing optical element 103 has a characteristic as shown in FIG. 2(a) and FIG. 2(b), and the operation of this embodiment is explained with reference to FIG. 25 and FIG. 2.

In FIG. 25, signal beam 111 from optical transmission line 104 is applied to reception circuit 102 by way of saturable absorbing optical element 103. Saturable absorbing optical element 103 is provided with a nonlinear transmission characteristic that is dependent on the input light intensity as shown in FIG. 2(a) and FIG. 2(b), and has a characteristic such that a data pulse of high light intensity exceeds (saturates) the absorption capacity of the optical element and is transmitted, while a pulse of low light intensity is strongly absorbed and reduced. In other words, optical noise is suppressed in the signal beam outputted from saturable absorbing optical element 103, and a signal beam having an improved signal-to-noise ratio is applied to reception circuit 102. FIG. 2(a) shows a case in which an offset beam is used, and FIG. 2(b) shows a case in which an offset beam is not used. In a case in which the peak value of an input beam is not greater than the threshold as shown in FIG. 25(b) and a sufficient output optical pulse cannot be obtained, the addition of an offset beam as shown in FIG. 2(a) enables an adequate output optical pulse.

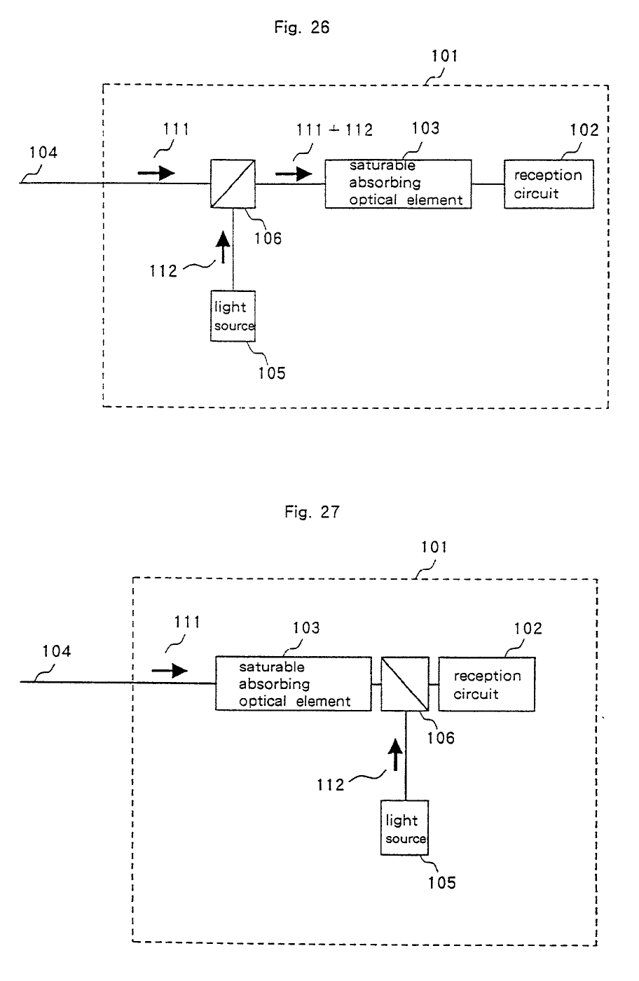

FIG. 26 is a block diagram showing the configuration of the twenty-fifth embodiment of the invention.

In this embodiment, light source 105 that generates offset beam 112, and optical mixer 106 that mixes signal beam 111 sent in from transmission line 104 and offset beam 112 sent in from light source 105 and outputs the mixed beams to saturable absorbing optical element 103 are provided in the twenty-fourth embodiment shown in FIG. 25. Signal beam 111 sent from transmission line 104 is mixed with offset beam 112 from light source 105 by means of optical mixer 106, and the mixed beams are applied to saturable absorbing optical element 103. In this case, optical mixer 106 is arranged in the section preceding saturable absorbing optical element 103 with respect to signal beam 111.

To explain the offset beam again in more detail, saturable absorbing optical element 103 is provided with a nonlinear transmission characteristic that is dependent on the input light intensity as shown in FIG. 2(a) and FIG. 2(b), and has a characteristic such that a data pulse of high light intensity exceeds (saturates) the absorption capacity of the optical element and is transmitted, but a pulse of low light intensity is strongly absorbed and reduced. This characteristic depends on the total input light intensity applied to saturable absorbing optical element 103. As a result, a continuous beam of higher intensity or an optical pulse synchronized to the signal beam must be applied from the outside as an offset beam for the transmission characteristic of saturable absorbing optical element 103 to increase the total input light intensity to saturable absorbing optical element 103, particularly for a case in which the signal beam itself is of low intensity. This embodiment is intended for a case in which the above-described signal itself is of low intensity, and the configuration as described above converts a signal beam outputted from saturable absorbing optical element 103 to a signal beam with suppressed optical noise and improved signal-to-noise ratio, and this signal beam is then outputted to reception circuit 102.

FIG. 27 is a block diagram showing the configuration of the twenty-sixth embodiment of the invention.

In this embodiment, the twenty-fourth embodiment shown in FIG. 25 is further provided with light source 105, which generates offset beam 112, and optical mixer 106, which mixes the output of saturable absorbing optical element 103 with the offset beam 112 sent in from light source 105 and outputs the result to reception circuit 102. Signal beam 111 sent from transmission line 104 is applied to optical mixer 106 by way of saturable absorbing optical element 103, offset beam 112 from light source 105 is applied to optical mixer 106, these two beams are mixed, and the result is sent to reception circuit 102. In this case, optical mixer 106 is arranged in the section following saturable absorbing optical element 103 with respect to signal beam 111.

Optical mixer 106 is arranged such that input offset beam 112 is outputted toward saturable absorbing optical element 103, and this embodiment exhibits the same operation and effect as the twenty-fifth embodiment shown in FIG. 25.

Optical mixer 106 used in either of the twenty-fifth and twenty-sixth embodiments of the invention is arranged such that the received offset beam is applied to saturable absorbing optical element 103, and this feature is equivalent in each of the embodiments described hereinbelow.

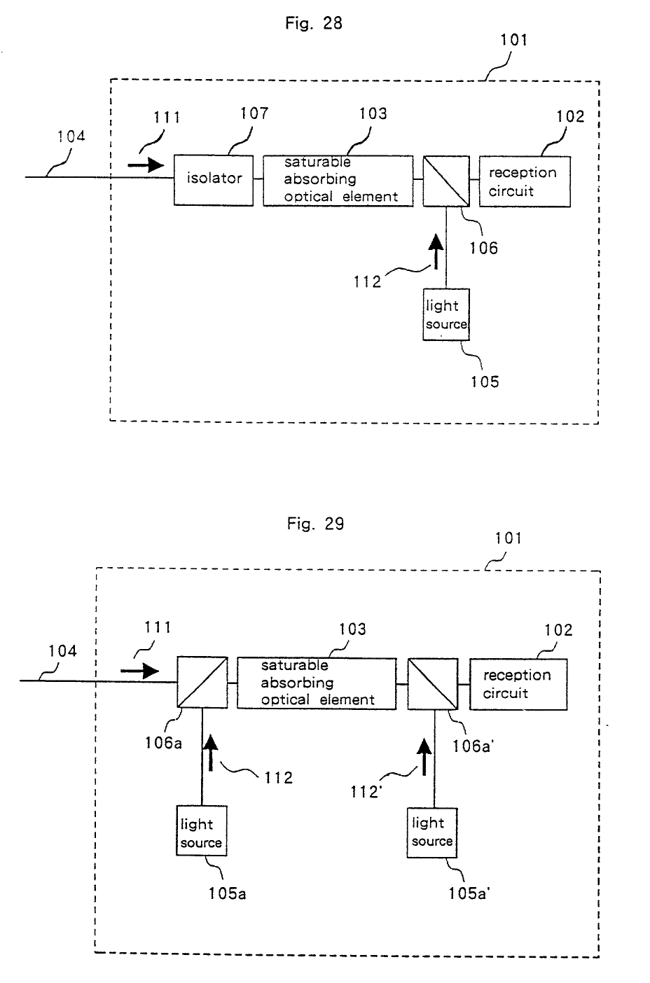

FIG. 28 is a block diagram showing the configuration of the twenty-seventh embodiment of the invention.

In this embodiment, isolator 107, which is a means that transmits light in only one direction toward reception circuit 102, is inserted on the transmission line 104 side of the twenty-sixth embodiment shown in FIG. 27.

The provision of isolator 107 in this embodiment prevents the input to transmission line 104 of offset beam 112 that is generated by light source 105, thereby preventing degradation of transmission characteristic in transmission line 104.

FIG. 29 is a block diagram showing the configuration of the twenty-eighth embodiment of the invention.

In this embodiment, the twenty-fourth embodiment shown in FIG. 25 is provided with light sources 110a and 105a′ that generate offset beams 112 and 112′, optical mixer 106a that mixes signal beam 111 from transmission line 104 and offset beam 112 sent in from light source 105a and outputs to saturable absorbing optical element 103, and optical mixer 106a′ that mixes the output of saturable absorbing optical element 103 with offset beam 112′ sent from light source 105a′ and outputs to reception circuit 102. Signal beam 111 sent from transmission line 104 is mixed by means of optical mixer 106a with offset beam 112 from light source 105a and then applied to saturable absorbing optical element 103. The output of saturable absorbing optical element 103 is mixed by means of optical mixer 106a′ with offset beam 112′ from light source 105a′ and then outputted to reception circuit 102. In this case, optical mixers 106a is arranged in the section preceding saturable absorbing optical element 106, and optical mixer 106a′ is arranged in the section following saturable absorbing optical element 103 with respect to signal beam 111.

The embodiment configured as described above combines the effects of each of the twenty-fifth and twenty-sixth embodiments and features an improved effect.

The configuration shown in FIG. 29 adopts a structure in which optical mixers 106a and 106a′ receive respective offset beams 112 and 112′ generated by different light sources 105a and 105a′, but a configuration may also be adopted in which an offset beam generated by a single light source is divided by means of an optical divider and then received by optical mixers 106a and 106a′.

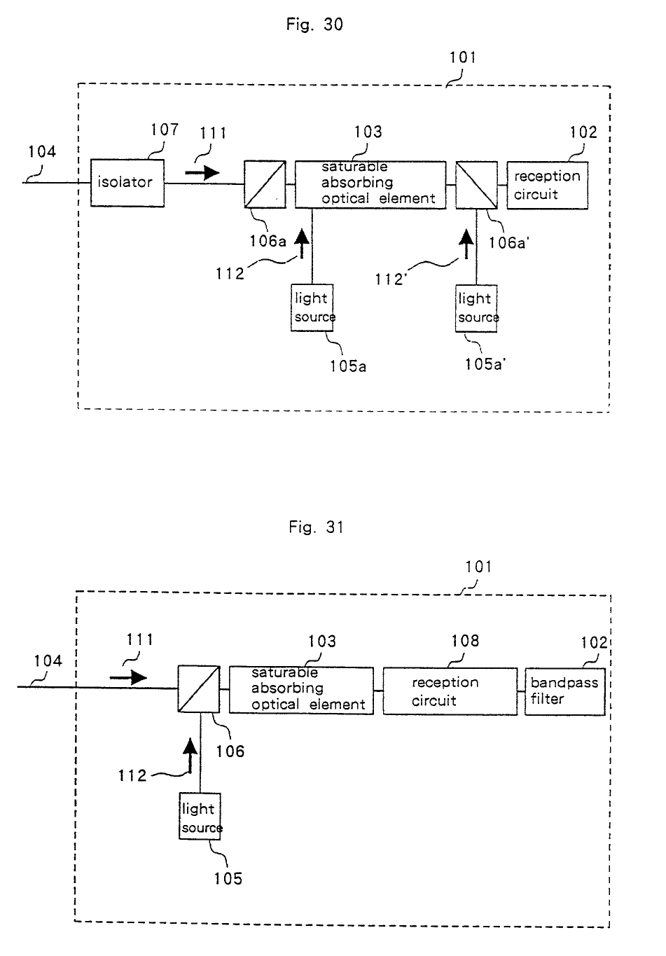

FIG. 30 is a block diagram showing the configuration of the twenty-ninth embodiment of the invention.

In this embodiment, isolator 107, which is a means for transmitting light in only one direction, is inserted on the transmission line 104 side of the twenty-eighth embodiment shown in FIG. 29.

In addition to the effect of the twenty-eighth embodiment, the provision of isolator 107 in this embodiment prevents the input of offset beam 112 that is generated by light source 105a to transmission line 104, and therefore prevents degradation of the transmission characteristic of transmission line 104.

FIG. 31 is a block diagram showing the configuration of the thirtieth embodiment of the invention.

In this embodiment, optical bandpass filter 108 such as a fiber grating is inserted between saturable absorbing optical element 103 and reception circuit 102 in the twenty-fifth embodiment shown in FIG. 26. Optical bandpass filter 108 is provided to eliminate offset beam 112 and has a characteristic such that the wavelength bandwidth of offset beam 112 is not transmitted, and the signal beam is therefore outputted to reception circuit 102 with the offset beam 112 component eliminated by optical bandpass filter 108.

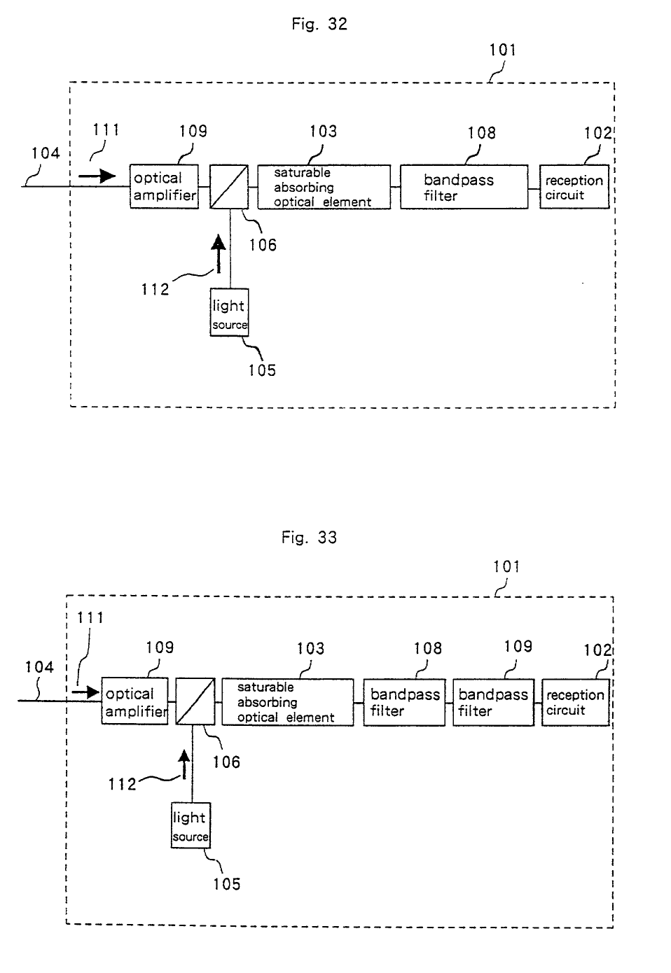

FIG. 32 is a block diagram showing the configuration of the thirty-first embodiment of the invention.

In this embodiment, optical amplifier 109 is inserted on the transmission line 104 side (in the section preceding saturable absorbing optical element 103) of the thirtieth embodiment shown in FIG. 31. Optical amplifier 109 is controlled by, for example, a constant-output control method, and regulation of the output of optical amplifier 109 according to the transmission characteristic of saturable absorbing optical element 103 enables both the effective suppression of optical noise and effective improvement of the signal-to-noise ratio of the signal beam.

FIG. 33 is a block diagram showing the configuration of the thirty-second embodiment of the invention.

In this embodiment, optical bandpass filter 108′ such as a fiber grating is further inserted between optical bandpass filter 108 and reception circuit 102 of the thirty-first embodiment shown in FIG. 32. Optical bandpass filter 108′ is for extracting only the signal beam wavelength component, and therefore has a characteristic such that only the signal beam bandwidth is transmitted and bandwidths other than that of the signal beam are blocked. The signal beam is thus outputted to reception circuit 102 after eliminating offset beam 112 by means of optical bandpass filter 108 and then allowing only the signal beam bandwidth to pass by means of optical bandpass filter 108′.

The adoption of a two-stage configuration of optical bandpass filters in this embodiment further improves the signal-to-noise ratio of the signal beam that is outputted to reception circuit 102.

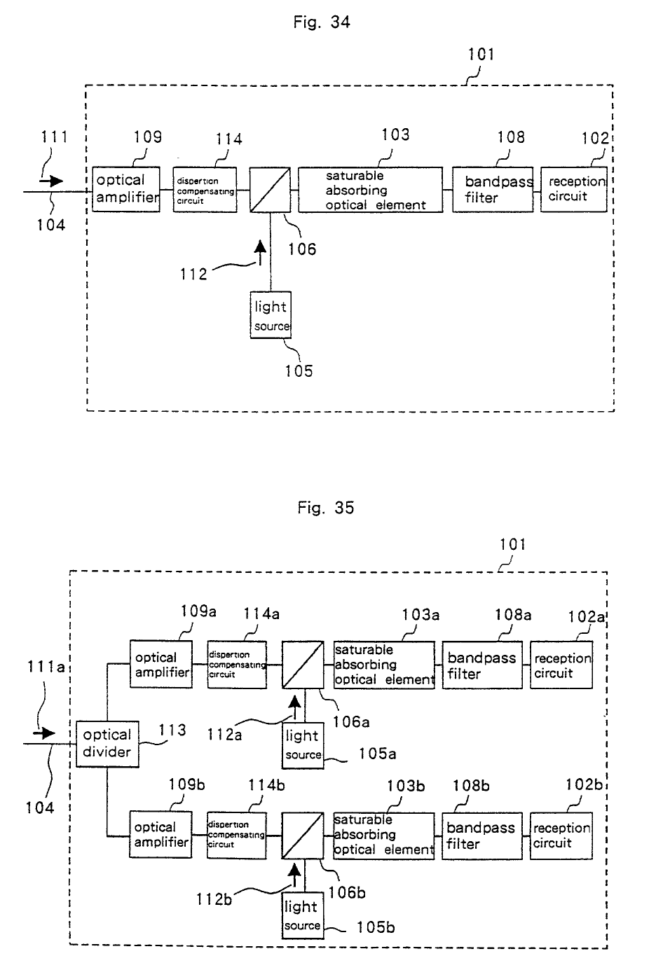

FIG. 34 is a block diagram showing the configuration of the thirty-third embodiment of the invention.

In this embodiment, dispersion compensating circuit 114 having the function of compensating dispersion in transmission line 104 is provided between optical amplifier 109 and optical mixer 106 in the thirty-first embodiment shown in FIG. 32. This embodiment enables a reduction in the effect of dispersion in transmission line 104.

FIG. 35 is a block diagram showing the configuration of the thirty-fourth embodiment of the invention.

This embodiment employs two sets of the configuration of the thirty-third embodiment shown in FIG. 34, and is configured such that signal beam 111 received from transmission line 104 is divided by optical divider 113 and supplied to each set. In FIG. 35, the letter “a” marks one set and the letter “b” marks the other, and the same form of identification is used in the other embodiments directed to multiplexing described hereinbelow. This embodiment allows wavelength division multiplex transmission and enables an increase in the transmission volume.

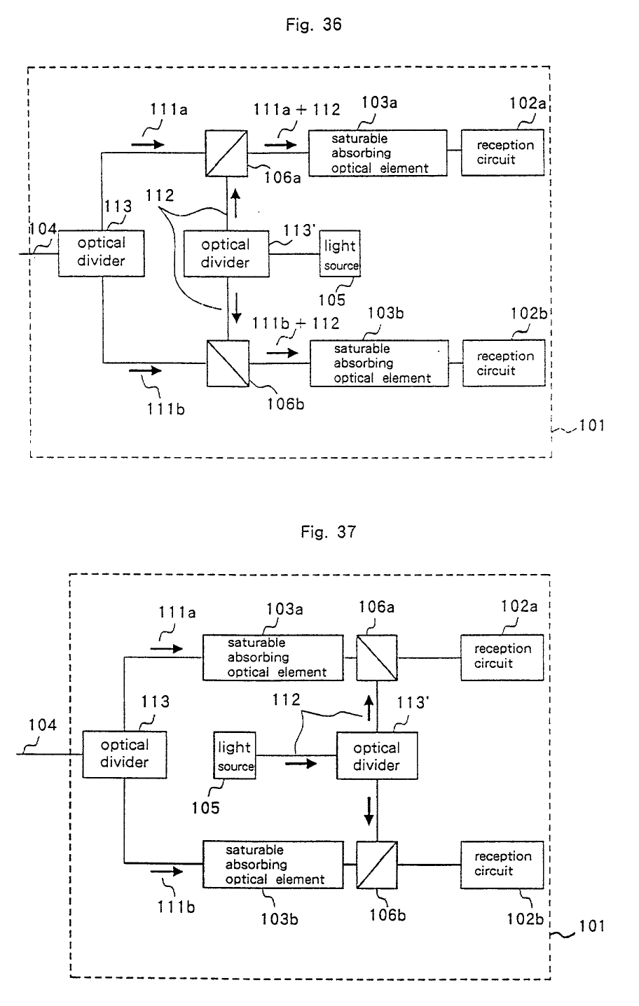

FIG. 36 is a block diagram showing the configuration of the thirty-fifth embodiment of the invention.

This embodiment is intended for wavelength division multiplex transmission using two sets of a structure equivalent to that of the twenty-fifth embodiment shown in FIG. 26, and further seeks to simplify the device structure by sharing the light source that generates the offset beam.

The signal beam received from transmission line 104 is first divided by optical divider 113. One signal beam 111a is applied to optical mixer 106a, mixed with offset beam 112 that is generated by light source 105 and divided by optical divider 113′, applied to saturable absorbing optical element 103a to be converted to a pulse waveform having a reduced noise component, and then applied to reception circuit 102a. The other signal beam 111b is applied to optical mixer 106b, mixed with offset beam 112 that is also generated by light source 105 and divided by optical divider 113′, applied to saturable absorbing optical element 103b to be converted to a pulse waveform having a reduced noise component, and then applied to reception circuit 102b.

In an embodiment configured as described above, the use of optical divider 113′ to share offset beam 112 between two different saturable absorbing optical elements 103a and 103b enables a reduction in the number of light sources for generating the offset beams for each saturable absorbing optical element, and thus allows a more compact design and a lower cost.

FIG. 37 is a block diagram showing the configuration of the thirty-sixth embodiment of the invention.

This embodiment is intended for wavelength division multiplex transmission using two sets of a configuration equivalent to that of the twenty-sixth embodiment shown in FIG. 27, and in addition, seeks a simplification of the device structure by sharing the light source for generating offset beams.

A signal beam received from transmission line 104 is first divided by optical divider 113. One signal beam 111a is then applied to saturable absorbing optical element 103a to be converted to a pulse waveform having reduced noise component, following which it is applied to optical mixer 106a to be mixed with offset beam 112 that is generated by light source 105 and divided by optical divider 113′, and then applied to reception circuit 102a. The other signal beam 111b is applied to saturable absorbing optical element 103b to be converted to a pulse waveform having a reduced noise component, following which it is applied to optical mixer 106b to be mixed with offset beam 112 that is also generated in light source 105 and divided by optical divider 113′, and then applied to reception circuit 102b.

In the embodiment configured as described above, the use of optical divider 113′ to share offset beam 112 between two different saturable absorbing optical elements 103a and 103b enables a reduction in the number of light sources for generating the offset beams for each saturable absorbing optical element, and thus allows a more compact design and a lower cost.

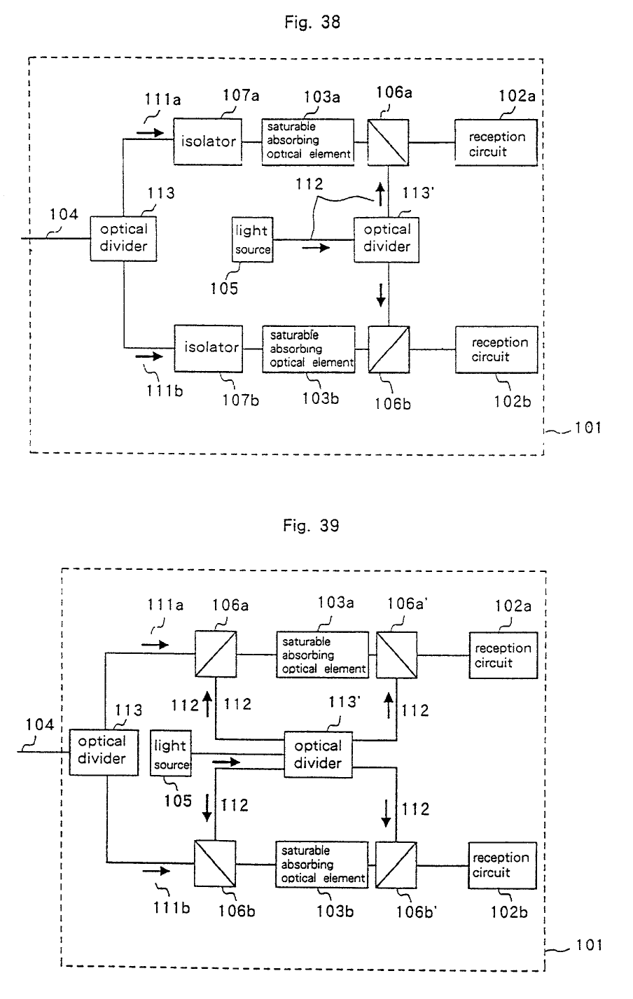

FIG. 38 is a block diagram showing the configuration of the thirty-seventh embodiment of the invention.

In this embodiment, isolators 107a and 107b, which are means for transmitting light in only one direction, are inserted between optical divider 113 and each of saturable absorbing optical elements 103a and 103b.

In addition to the effect of the thirty-sixth embodiment, the provision of isolators 107a and 107b in this embodiment prevents the input of offset beam 112 generated by light source 105 to transmission line 104 and therefore prevents the degradation of transmission characteristic of transmission line 104.

FIG. 39 is a block diagram showing the configuration of the thirty-eighth embodiment of the invention.

This embodiment is intended for wavelength division multiplex transmission by employing two sets of a construction equivalent to that of the twenty-eighth embodiment shown in FIG. 29, and in addition, seeks a simplification of the device structure by sharing the light source for generating the offset beams.

A signal beam received from transmission line 104 is first divided by optical divider 113. One signal beam 111a is mixed by means of optical mixer 106a with offset beam 112 that is generated by light source 105 and divided by optical divider 113′, and then applied to saturable absorbing optical element 103a. The output of saturable absorbing optical element 103a is mixed by means of optical mixer 106a′ with offset beam 112 that is generated by light source 105 and divided by optical divider 113′, and then sent to reception circuit 102a. In this case, optical mixers 106a and 106a′ are arranged in the sections preceding and following saturable absorbing optical element 103a with respect to signal beam 111a. The other signal beam 111b is mixed by means of optical mixer 106b with offset beam 112 that is generated by light source 105 and divided by optical divider 113′, and then applied to saturable absorbing optical element 103b. The output of saturable absorbing optical element 103b is mixed by optical mixer 106b′ with offset beam 112 that is generated by light source 105 and divided by optical divider 113′, and then sent to reception circuit 102b. Again, optical mixers 106b and 106b′ are arranged in the sections preceding and following saturable absorbing optical element 103b with respect to signal beam 111b.

In the embodiment configured as described above, the use of optical divider 113′ to share offset beam 112 among four different optical mixers 106a, 106a′, 106b, and 106b′ enables a reduction in the number of light sources for generating the offset beams for each saturable absorbing optical element, and thus allows a more compact design and a lower cost.

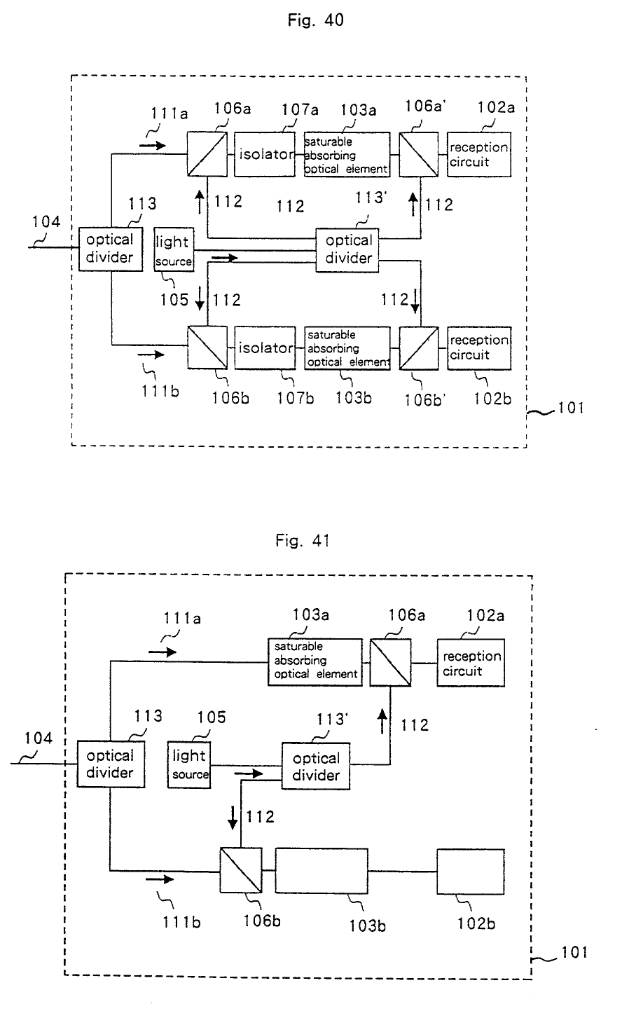

FIG. 40 is a block diagram showing the configuration of the thirty-ninth embodiment of the invention.

This embodiment employs isolators 107a and 107b, which are means for transmitting light in only one direction toward the reception circuit. Isolator 107a is inserted between optical mixer 106a and saturable absorbing optical element 103a, and isolator 107b is inserted between optical mixer 106b and saturable absorbing optical element 103b.

In addition to the effect of the thirty-eighth embodiment, the provision of isolators 107a and 107b in this embodiment prevents the input of offset beam 112 generated by light source 105 to transmission line 104, and therefore prevents degradation of the transmission characteristic of transmission line 104.

FIG. 41 is a block diagram showing the configuration of the fortieth embodiment of the invention.

This embodiment is directed to wavelength division multiplex transmission through the use of two sets of reception systems containing reception circuits, and in addition, seeks a simplification of the device structure by sharing the light sources that generate the offset beams.

A signal beam received from transmission line 104 is first divided by means of optical divider 113. One signal beam 111a is applied to saturable absorbing optical element 103a to be converted to pulse waveform having a reduced noise component, then applied to optical mixer 106a where it is mixed with offset beam 112 that is generated by light source 105 and divided optical divider 113′, and then applied to reception circuit 102a. The other signal beam 111b is applied to optical mixer 106b where it is mixed with offset beam 112 that is generated by light source 105 and divided by optical divider 113′, then applied to saturable absorbing optical element 103b to be converted to a pulse waveform having a reduced noise component, and then applied to reception circuit 102b.

In the embodiment configured as described above, the use of optical divider 113′ to share offset beam 112 between two different saturable absorbing optical elements 103a and 103b enables a reduction in the number of light sources for generating the offset beams for each saturable absorbing optical element, and thus allows a more compact design and a lower cost.

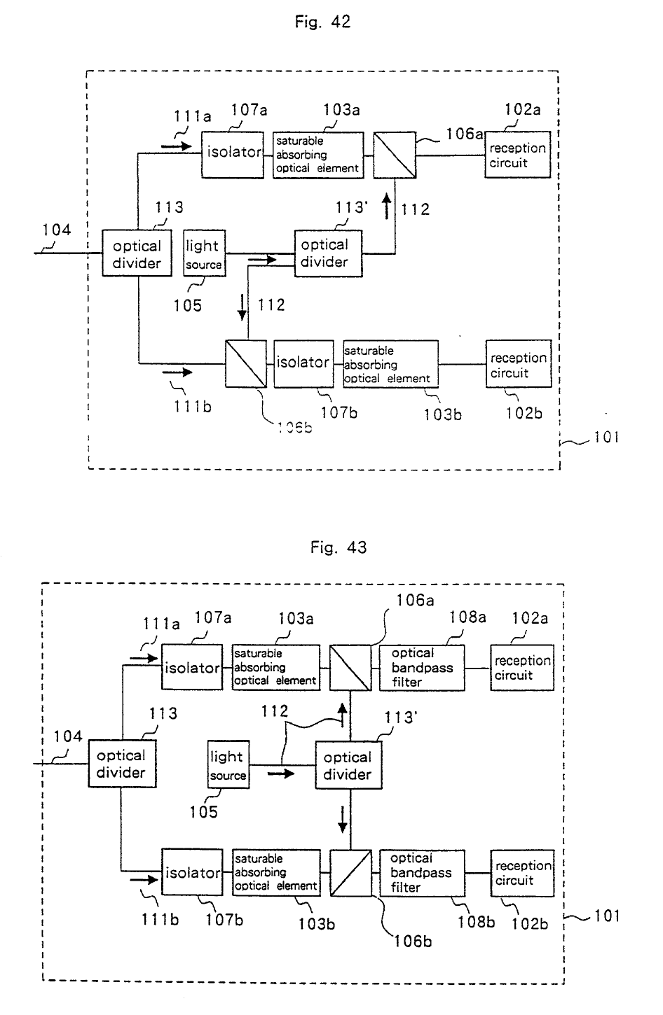

FIG. 42 is a block diagram showing the configuration of the forty-first embodiment of the invention.

In this embodiment, isolators 107a and 107b, which are means for transmitting light in only one direction toward reception circuits 102a and 102b, are inserted in the fortieth embodiment shown in FIG. 41, isolator 107a being inserted between optical divider 113 and saturable absorbing optical element 103a, and isolator 107b being inserted between optical mixer 106b and saturable absorbing optical element 103b.

In addition to the effect of the fortieth embodiment, the provision of isolators 107a and 107b in this embodiment further prevents the input of offset beam 112 generated by light source 105 to transmission line 104 and therefore prevents degradation of the transmission characteristic of transmission line 104.

FIG. 43 is a block diagram showing the configuration of the forty-second embodiment of the invention.

In this embodiment, optical bandpass filters 108a and 108b such as a fiber grating are inserted in the sections following optical mixers 106a and 106b, respectively, of the thirty-seventh embodiment shown in FIG. 38. Optical bandpass filters 108a and 108b are provided for eliminating offset beam 112 and have a characteristic such that the wavelength bandwidth of offset beam 112 is not transmitted. The signal beam is thus outputted to reception circuits 102a and 102b with the offset beam 112 component eliminated by optical bandpass filters 108a and 108b.

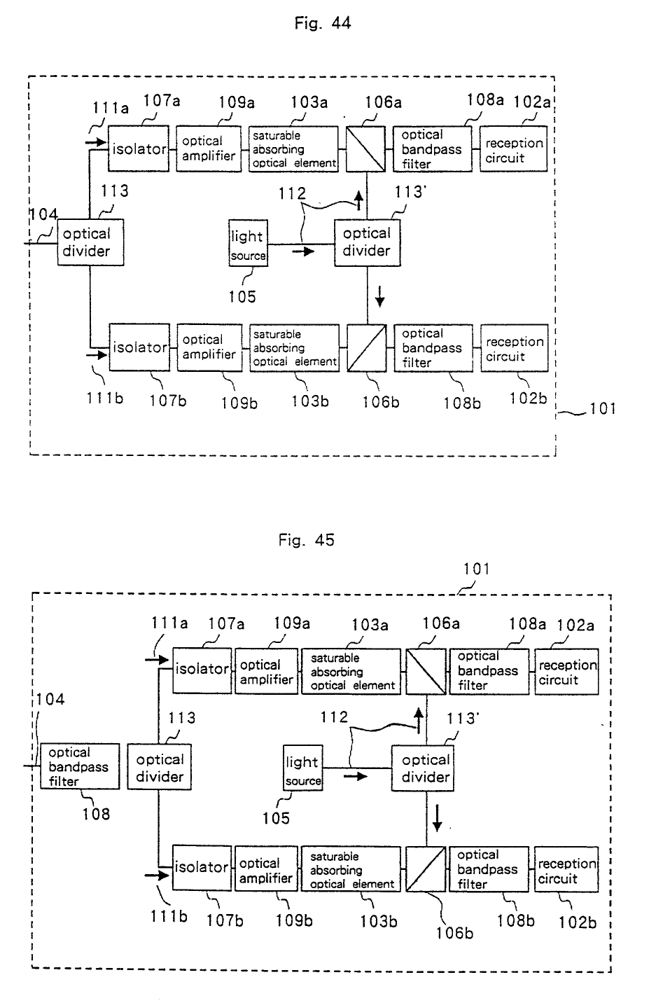

FIG. 44 is a block diagram showing the configuration of the forty-third embodiment of the invention.

In this embodiment, optical amplifiers 109a and 109b are inserted in the sections preceding saturable absorbing optical elements 103a and 103b, respectively, of the forty-second embodiment shown in FIG. 43. Optical amplifiers 109a and 109b are controlled by, for example, a constant-output control method, and regulation of the output of optical amplifiers 109a and 109b according to the transmission characteristic of saturable absorbing optical elements 103a and 103b therefore enables the effective suppression of optical noise and the effective improvement of the signal-to-noise ratio of the signal beam.

FIG. 45 is a block diagram showing the configuration of the forty-fourth embodiment of the invention.

In this embodiment, optical bandpass filter 108 such as a fiber grating is inserted between optical divider 113 and transmission line 104 in the forty-third embodiment shown in FIG. 44. Optical bandpass filter 108 is for extracting only the signal beam wavelength component and therefore has a characteristic whereby only the signal beam bandwidth is allowed to pass and bandwidths other than that of the signal beam are blocked. A signal beam is therefore outputted to reception circuits 102a and 102b after passing only the signal beam bandwidth by means of optical bandpass filter 108 and then eliminating the offset beam 112 component by means of optical bandpass filters 108a and 108b.

The adoption of a two-stage configuration of optical bandpass filters in this embodiment affords a further improvement in the signal-to-noise ratio.

FIG. 46 is a block diagram showing the configuration of the forty-fifth embodiment of the invention.

In this embodiment, optical bandpass filters 108a′ and 108b′ such as fiber gratings are further inserted in the forty-third embodiment shown in FIG. 44, optical bandpass filter 108a′ being inserted between optical bandpass filter 108a and reception circuit 102a, and optical bandpass filter 108b′ being inserted between optical bandpass filter 108b and reception circuit 102b. Optical bandpass filters 108a′ and 108b′ are for extracting only the signal beam wavelength component and therefore have a characteristic whereby only the signal beam bandwidth is allowed to pass and bandwidths other than that of the signal beam are blocked. A signal beam is therefore outputted to reception circuits 102a and 102b after the offset beam 112 component has been eliminated by optical bandpass filters 108a and 108b and only the signal beam bandwidth is transmitted by optical bandpass filters 108a′ and 108b′.

In addition to the effect of the forty-third embodiment, the adoption of a two-stage configuration of optical bandpass filters in this embodiment enables a further improvement in the characteristic for eliminating the offset beam 112 component.

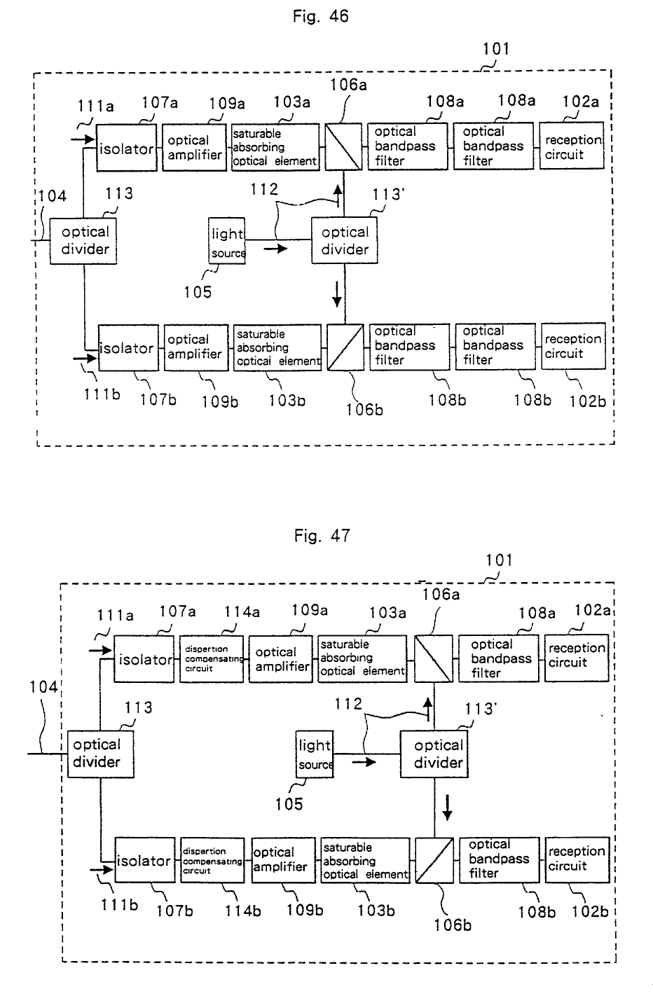

FIG. 47 is a block diagram showing the configuration of the forty-sixth embodiment of the invention.

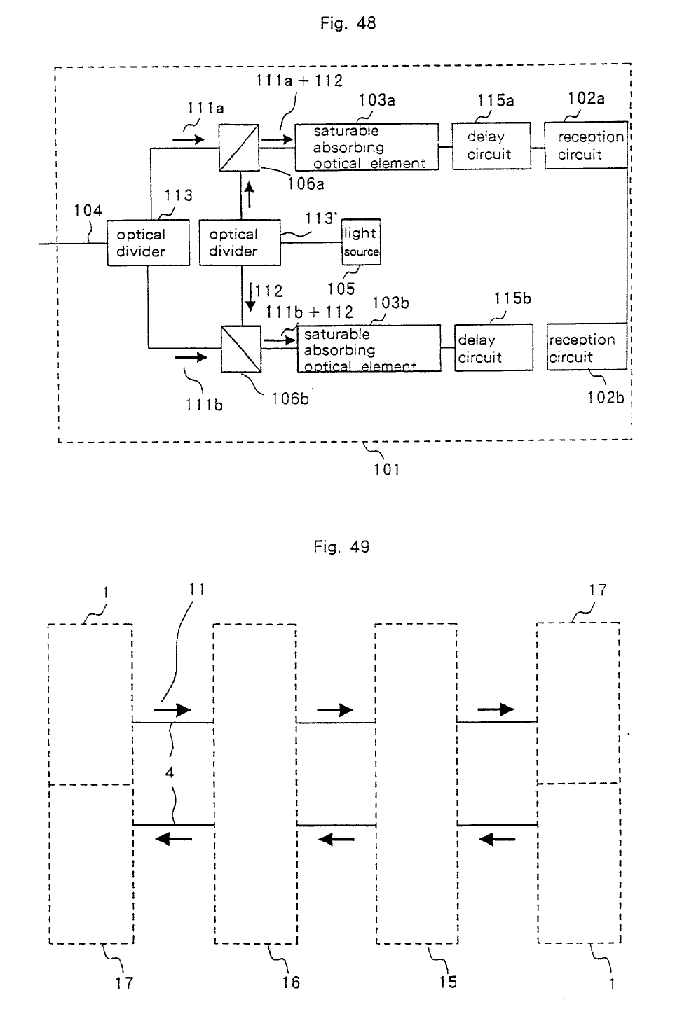

In this embodiment, dispersion compensating circuits 114a and 114b having the function of compensating dispersion in transmission line 104 are provided in the sections preceding optical amplifiers 109a and 109b in the forty-third embodiment shown in FIG. 44. In addition to the effect of the forty-third embodiment, this embodiment enables a further reduction of the effect of dispersion in transmission line 104. FIG. 48 is a block diagram showing the configuration of the forty-seventh embodiment of the invention.

In this embodiment, delay circuits 115a and 115b, which output an input signal after delaying for a prescribed time interval, are inserted in the thirty-fifth embodiment shown in FIG. 36, delay circuit 115a being inserted between saturable absorbing optical element 103a and reception circuit 102a, and delay circuit 115b being inserted between saturable absorbing optical element 103b and reception circuit 102b. The output signal of saturable absorbing optical elements 103a and 103b in this embodiment are received by reception circuits 102a and 102b after being given a time differential by delay circuits 115a and 115b, thereby enabling time division multiplex transmission.

FIG. 49 is a block diagram showing the configuration of the forty-eighth embodiment of the invention.

This embodiment is an optical transmission system that uses optical transmitter 1 described in the first to twenty-third embodiments. In this system, optical transmitter 1, optical receiver 17, and a plurality of optical repeaters 15 and 16 provided between optical transmitter 1 and optical receiver 17 are connected by transmission line 4 , and communication is realized by transmitting optical signal 11.

Optical transmitter 1 has characteristics as described in the first to twenty-third embodiments, and as a result, both the signal-to-noise ratio of the signal beam and the transmission characteristics can be improved.

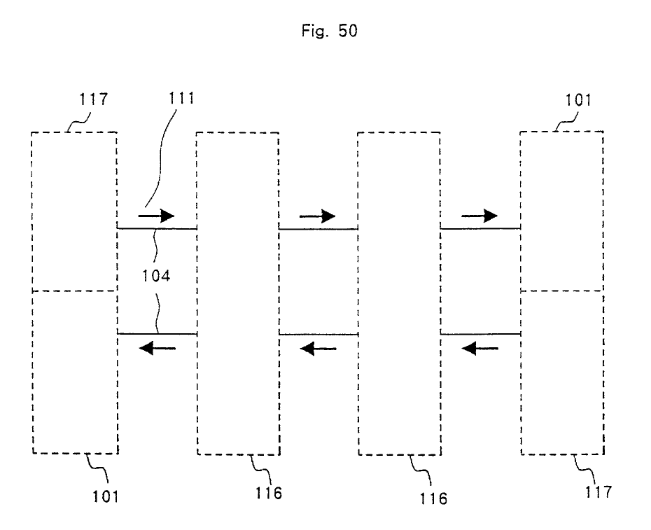

FIG. 50 is a block diagram showing the configuration of the forty-ninth embodiment of the invention.

This embodiment is an optical transmission system that uses optical receiver 101 described in the twenty-fourth to forty-seventh embodiments. In this system, optical receiver 101, optical transmitter 117, and a plurality of optical repeaters 115 and 116 between optical receiver 101 and optical transmitter 117 are is realized by transmitting optical signal 111.

Optical receiver 101 has the characteristics described in the twenty-fourth to forty-seventh embodiments, and as a result, both the signal-to-noise ratio of the signal beam and the transmission characteristics can be improved.

In addition, the number and positions of arrangement of such components as the optical amplifier, optical bandpass filter (wavelength selecting means), and dispersion compensating circuit in the above-described optical transmitter and optical receiver are not limited by the above-described embodiments, and these components may be arranged in any plurality and in any position through which optical signals are transmitted. Further, the components may of course be assembled in arrangements not described in the embodiments above.

The configuration of the invention as described hereinabove provides the following effects:

A signal beam is received via a saturable absorbing optical element that absorbs a signal if the output intensity of the input signal beam is below a particular value (threshold) and allows the signal to pass unaltered if the output intensity of the input signal beam is above the value, thereby enabling suppression of optical noise during passage through the saturable absorbing optical element and an improvement in the signal-to-noise ratio of the signal beam.

While preferred embodiments of the present invention have been described using specific terms, such description is for illustrative purposes only, and it is to be understood that changes and variations may be made without departing from the spirit or scope of the following claims.

What is claimed is:

1. An optical transmitter that transmits a signal beam generated by a transmission circuit to a transmission line, comprising:
a saturable absorbing optical element having a saturable absorbing region that receives a signal beam generated by said transmission circuit and outputs to a transmission line.

2. An optical transmitter that transmits a signal beam generated by a transmission circuit to a transmission line, comprising:
a light source that generates an offset beam:
an optical mixer that receives a signal beam generated by said transmission circuit and an offset beam generated by said light source and mixes these two beams; and
a saturable absorbing optical element having a saturable absorbing region that receives output of said optical mixer and outputs to a transmission line.

3. An optical transmitter that transmits a signal beam generated by a transmission circuit to a transmission line, comprising:
a light source that generates an offset beam; a saturable absorbing optical element having a saturable absorbing region that receives a signal beam generated by said transmission circuit; and
an optical mixer that receives an offset beam generated by said light source and outputs said offset beam toward said saturable absorbing optical element, and outputs output of said saturable absorbing optical element to a transmission line.

4. An optical transmitter that transmits a signal beam generated by a transmission circuit to a transmission line, comprising:
first and second light sources that generate first and second offset beams;
a first optical mixer that receives a signal beam generated by said transmission circuit and said first offset beam generated by said first light source and mixes these two beams;
a saturable absorbing optical element having a saturable absorbing region that receives output of said first optical mixer; and
a second optical mixer that receives said second offset beam generated by said second light source and outputs said second offset beam toward said saturable absorbing optical element, and outputs output of said saturable absorbing optical element to a transmission line.

5. An optical transmitter that transmits a signal beam generated by a transmission circuit to a transmission line, comprising:
a light source that generates an offset beam; an optical dividing means that receives an offset beam generated by said light source, divides said offset beam into first and second offset beams, and outputs said first and second offset beams;
a first optical mixer that receives a signal beam generated by said transmission circuit and said first offset beam divided by said optical dividing means and mixes these two beams;
a saturable absorbing optical element having a saturable absorbing region that receives output of said first optical mixer; and
a second optical mixer that receives said second offset beam divided by said optical dividing means, outputs said second offset beam toward said saturable absorbing optical element, and outputs output of said saturable absorbing optical element to a transmission line.

6. A wavelength division multiplex optical transmitter, comprising:
a plurality of optical transmitters constructed according to claim 1 that each generate a signal beam of different wavelength; and
an optical coupler that multiplexes each signal beam from said plurality of transmitters and transmits to a transmission line.

7. An optical transmitter, comprising:
a plurality of transmitter systems, each made up of a transmission circuit that generates a signal beam, an optical mixer that receives a signal beam generated by said transmission circuit and an offset beam and mixes these two beams, and a saturable absorbing optical element having a saturable absorbing region that receives output of said optical mixer;
a light source that generates an offset beam;
an optical dividing means that receives an offset beam generated by said light source, divides said offset beam into a plurality of offset beams, and supplies an offset beam to each of said optical mixers that form a part of said plurality of transmission systems; and
an optical coupler that multiplexes a plurality of signal beams outputted from said plurality of transmission systems.

8. An optical transmitter, comprising:
a plurality of transmission systems, each made up of a transmission circuit that generates a signal beam, a saturable absorbing optical element having a saturable absorbing region that receives a signal beam generated by said transmission circuit, and an optical mixer that forms the output section of said saturable absorbing optical element that receives an offset beam generated by said light source, and that outputs said offset beam toward said saturable absorbing optical element;
a light source that generates an offset beam; an optical dividing means that receives an offset beam generated by said light source, divides said offset beam into a plurality of offset beams, and supplies an offset beam to each of said optical mixers that form a part of said plurality of transmission systems; and
an optical coupler that multiplexes the plurality of signal beams outputted from said plurality of transmission systems.

9. An optical transmitter, comprising:
a plurality of transmission systems, each made up of a transmission circuit that generates a signal beam, a first optical mixer that receives a signal beam generated by said transmission circuit and an offset beam and mixes these two beams, a saturable absorbing optical element having a saturable absorbing region that receives output of said first optical mixer, and a second optical mixer that forms the output section of said saturable absorbing optical element, that receives an offset beam generated by said light source, and that outputs said offset beam toward said saturable absorbing optical element;
a light source that generates an offset beam; an optical dividing means that receives an offset beam generated by said light source, divides said offset beam into a plurality of offset beams, and supplies an offset beam to each of said first and second optical mixers that form a part of said plurality of transmission systems; and
an optical coupler that multiplexes said plurality of signal beams outputted from said plurality of transmission systems.

10. A time division multiplex optical transmitter, comprising:
a plurality of optical transmitters constructed according to claim 1 that each generate a different signal beam;
a plurality of delay circuits provided in each of said plurality of optical transmitters that each give a time difference to a signal beam transmitted to a transmission line; and
an optical coupler that multiplexes each signal beam from said plurality of delay circuits and transmits to a transmission line.

11. A time division multiplex optical transmitter that uses an optical transmitter constructed according to claim 7, comprising:
a plurality of delay circuits provided in each of said plurality of transmission systems that each give a time difference to a signal beam transmitted to a transmission line; and
an optical coupler that multiplexes each signal beam from said plurality of delay circuits and transmits to a transmission line.

12. An optical transmission system constituted by using an optical transmitter according to claim 1.

13. An optical transmission system constituted by using an, optical transmitter according to claim 7.

14. An optical receiver that receives a signal beam from a transmission line by means of a reception circuit, comprising:
a saturable absorbing optical element having a saturable absorbing region that receives a signal beam from said transmission line and outputs to a reception circuit.

15. An optical receiver that receives a signal beam from a transmission line by means of a reception circuit, comprising:
a light source that generates an offset beam;
an optical mixer that receives a signal beam from said transmission line and an offset beam generated by said light source and mixes these two beams; and a saturable absorbing optical element having a saturable absorbing region that receives output of said optical mixer and outputs to a reception circuit.

16. An optical receiver that receives a signal beam from a transmission line by means of a reception circuit, comprising:
a light source that generates an offset beam;
a saturable absorbing optical element having a saturable absorbing region that receives a signal beam from said transmission line; and
an optical mixer that receives an offset beam generated by said light source, outputs said offset beam toward said saturable absorbing optical element, and outputs the output of said saturable absorbing optical element to a reception circuit.

17. An optical receiver that receives a signal beam from a transmission line by means of a reception circuit, comprising:
a first and second light source that generate a first and second offset beam;
a first optical mixer that receives a signal beam from said transmission line and said first offset beam generated by said first light source and mixes these two beams;
a saturable absorbing optical element having a saturable absorbing region that receives output of said first optical mixer; and
a second optical mixer that receives said second offset beam generated by said second light source, outputs said offset beam toward said saturable absorbing optical element, and outputs the output of said saturable absorbing optical element to a reception circuit.

18. An optical receiver that receives a signal beam from a transmission line by means of an reception circuit, comprising:
a light source that generates an offset beam;
an optical dividing means that receives an offset beam generated by said light source, divides said offset beam into first and second offset beams, and outputs said offset beams;
a first optical mixer that receives a signal beam from said transmission line and said first offset beam divided by said optical dividing means and mixes these two beams;
a saturable absorbing optical element having a saturable absorbing region that receives output of said first optical mixer; and
a second optical mixer that receives said second offset beam divided by said optical dividing means, outputs said second offset beam toward said saturable absorbing optical element, and outputs the output of said saturable absorbing optical element to said reception circuit.

19. A wavelength division multiplex optical receiver, comprising:
a plurality of optical receivers constructed according to claim 14 that each receive a signal beam of different wavelength; and
an optical divider each signal beam from said transmission line and transmits to each optical receiver.

20. An optical receiver, comprising:
a plurality of reception systems, each made up of an optical mixer that receives a signal beam and an offset beam and mixes these two beams, a saturable absorbing optical element having a saturable absorbing region that receives output of said optical mixer, and a reception circuit that receives output of said saturable absorbing optical element;
a light source that generates an offset beam; an optical dividing means that receives an offset beam generated by said light source, divides said offset beam into a plurality of offset beams, and supplies an offset beam to each of said optical mixers forming a part of said plurality of reception systems; and
an optical divider that divides a plurality of signal beams from a transmission line and supplies said divided signal beams as signal beams to said plurality of reception systems.

21. An optical receiver, comprising:
a plurality of reception systems, each made up of a saturable absorbing optical element having a saturable absorbing region that receives a signal beam, an optical mixer that forms the output section of said saturable absorbing optical element and that receives an offset beam generated by said light source and outputs said offset beam toward said saturable absorbing optical element, and a reception circuit that receives said output of said optical mixer;
a light source that generates an offset beam; an optical dividing means that receives an offset beam generated by said light source, divides said offset beam into a plurality of offset beams, and supplies an offset beam to each of said optical mixers that form a part of said plurality of reception systems; and
an optical divider that divides a plurality of signal beams from a transmission line and supplies said divided signal beams as signal beams to said plurality of reception systems.

22. An optical receiver, comprising:
a plurality of reception systems each made up of a first optical mixer that receives a signal beam and an offset beam and mixes these two beams, a saturable absorbing optical element having a saturable absorbing region that receives output of said first optical mixer, a second optical mixer that forms the output section of said saturable absorbing optical element and that receives an offset beam generated by said light source and outputs said offset beam toward said saturable absorbing optical element, and a reception circuit that receives output of said second optical mixer;
a light source that generates an offset beam;
an optical dividing means that receives an offset beam generated by said light source, divides said offset beam into a plurality of offset beams, and supplies an offset beam to each of said first and second optical mixers that form a part of said plurality of reception systems; and
an optical divider that divides a plurality of signal beams from a transmission line and supplies said divided signal beams as signal beams to said plurality of reception systems.

23. A time division multiplex optical receiver, comprising:
a plurality of optical receivers constructed according to claim 14;
a plurality of delay circuits provided for each of said plurality of optical receivers that each give a time difference to received signal beams; and
an optical divider that divides signal beams from a transmission line and transmits to each of said optical receivers.

24. A time division multiplex optical receiver that uses an optical receiver constructed according to claim 20, comprising:
a plurality of delay circuits, provided in each of said plurality of reception systems, that each give a time difference to received signal beams; and an optical divider that divides signal beams from a transmission line and transmits to each of said optical receivers.

25. An optical transmission system constituted by using any of optical receivers according to claim 14.

26. An optical transmission system constituted by using any of optical receivers according to claim 20.
